(19) United States
(12) Patent Application Publication
(10) Pub. No.: US 2002/0069137 A1
(43) Pub. Date: Jun. 6, 2002

(54) Method for recycle management of product

(76) Inventors: Yuzo Hiroshige, Tokyo (JP); Masakazu Sakaue, Atsugi (JP); Gunzoh Takao, Ichikawa (JP); Junichi Shionoya, Funabashi (JP); Kumajiro Karube, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/916,140

(22) Filed: Jul. 25, 2001

(30) Foreign Application Priority Data
Jul. 28, 2000 (JP) 2000-233163

(51) Int. Cl. G06F 17/60

(52) U.S. Cl. 705/27

(57) ABSTRACT

The movement of products, information and costs is efficiently managed at low cost in the collection and recycling of home products.

A system is provided where, for managing the flow of collection and recycling of home products, required information is managed between a center which manages the whole, a collection applicant, a collection company, a disassembly company and a manufacturer, and required information is exchanged between the parties concerned. The collection applicant transmits information such as information about home products which it is desired to have collected and information about the location from which they are to be collected, the management center requests the collection company to collect the products, the collection company performs the collection and recovers a fee, the collection items are delivered to a disassembly company, and the disassembly company performs appropriate re-use and recycling, while analyzing the recycle rate and lowering costs. The location of collection items can be verified by transmitting information to the management center at each stage.

### FIELD OF THE INVENTION

The present invention relates to management data items and data exchange method between parties comprising a collection applicant, manufacturer/reseller of a collected product, collection company, disassembly company and overall management company within the context of a collection application, discharge, collection, delivery, re-use and recycle process to support recycling by the society when apparatus/fixtures (referred to hereafter as home products) used by homes and small businesses such as electrical apparatus, bicycles, motorcycles or furniture, and equipment, apparatus or fixtures attached thereto become worn out.

### BACKGROUND OF THE INVENTION

Conventionally, when household products became worn out, they were merely collected by an autonomous body and some of their metal was recycled. For products used by small businesses, recycled products were generally managed only in delivery units but not in individual collection units, and the management itself was limited to paperwork. In particular, the re-use of products and parts had no social or systematic function.

When products used in the home are collected/recycled, their whereabouts are managed in individual units. From the viewpoint of a collection applicant, knowing that a product which has been discarded at his/her cost has been collected, delivered, re-used and recycled prevents illegal throwing away of products, and is also important to encourage cost sharing. From the viewpoint of a manufacturer of electrical goods or a company which has undertaken collection, re-use or recycling processing, it is important that the cost is recovered, and appropriately and smoothly shared between the parties involved, and important to manage the re-use and recycle processing of products from the viewpoint of delivery, acceptance, disassembly and recycle rate.

Regarding the collection/recycling of products used in small businesses in individual small units, identical problems are encountered to those of products used in the home, but if products are managed one at a time, collection and recycling costs are often huge and difficult to recover.

Hence, it was necessary to correctly manage the flow of collection/recycling, the parties involved and cost in collected product individual units, but as this was formerly done mainly by autonomous bodies, recycling management was inadequate or remained at the paperwork level, and was difficult to track in practice.

Also, regarding the recycle rate in the collection/recycling process, the importance of management is increasing, but up to now the processes after disassembly were unclear, and even if they were known, they remained at the level of an approximation.

### SUMMARY OF THE INVENTION

It is therefore an object of the invention, which aims to resolve the above problems, to provide a method and system capable of managing collection/recycling flow and cost flow for home products. In particular, it aims to provide a system which is not only recycles products as materials, but also supports the kind of recycling that includes the efficient re-use of products and parts, this being the most important use of recycling in the society.

To resolve the above problems, the invention provides a system which manages a reception management center which provides total management as a means of managing the collection/recycling flow of household products together with information required by collection companies, disassembly companies and equipment manufacturers, and which exchanges required information between relevant parties.

An applicant who applies for the collection of household products transmits information concerning the household products he/she desires to have collected and the desired collection location to the reception management center. Based on this information, the reception management center requests a collection company to collect the products, and recovers the cost at the same time when they are collected. After the equipment collected by the collection company is subjected to a re-use/recycle process for products/parts based on the equipment manufacturers collection/recycle policies, they are delivered to the disassembly company, and the disassembly company recycles the delivered products as may be appropriate.

At each stage, the location of the equipment can be verified by sending information to the reception management center. By clarifying the collection/recycle process, and understanding the process details of the processing company which mainly performs material recycling according to instructions from the disassembly company, the recycle rate can be known more precisely.

By performing appropriate recycling and clarifying the process involved, an effort may be made to reduce the cost involved in collection/recycling. Further, a system which appropriately manages the costs recovered by the collection company also permits cost sharing among the various companies.

By requesting the reception management center, the collection applicant can know the status of a piece of equipment for which he/she has applied to be collected.

### BRIEF DESCRIPTION OF THE DRAWINGS

FIG. 1 is a diagram showing one example of the functions of an embodiment of the invention.

FIG. 2 is a diagram showing an example of a system construction according to an embodiment of the invention.

FIG. 3 is a diagram showing an example of a hardware construction according to an embodiment of the invention.

FIG. 4 is a diagram showing an example of overall work and processing flow according to an embodiment of the invention.

FIG. 5 is a diagram showing an example of a collection application screen according to an embodiment of the invention.

FIG. 6 is a diagram showing another example of the collection application screen according to an embodiment of the invention.

FIG. 7 is a diagram showing an example of a collection application detail check screen according to an embodiment of the invention.

FIG. 8 is a diagram showing an example of a collection and recycling cost recovery form according to an embodiment of the invention.

FIG. 9 is a diagram showing an example of a system diagram of a reception management center management system according to an embodiment of the invention.

FIG. 10 is a diagram showing an example of a reception management database according to an embodiment of the invention.

FIG. 11 is a diagram showing an example of a collection company database according to an embodiment of the invention.

FIG. 12 is a diagram showing an example of a recycle cost database according to an embodiment of the invention.

FIG. 13 is a diagram showing an example of a reception management center management system processing procedure according to an embodiment of the invention.

FIG. 14 is a diagram showing an example of a collection application information generation flow according to an embodiment of the invention.

FIG. 15 is a diagram showing an example of the detailed system construction of a collection management system according to an embodiment of the invention.

FIG. 16 is a diagram showing an example of a collection processing database according to an embodiment of the invention.

FIG. 17 is a diagram showing an example of a collection and recycling cost recovery form printing flow according to an embodiment of the invention.

FIG. 18 is a diagram showing an example of management flow relating to collection and recycling cost, and disassembly cost, according to an embodiment of the invention.

FIG. 19 is a diagram showing an example of the detailed system construction of a processing management system according to an embodiment of the invention.

FIG. 20 is a diagram showing an example of a parts collection center management system database according to an embodiment of the invention.

FIG. 21 is a diagram showing an example of disassembly acceptance management flow according to an embodiment of the invention.

FIG. 22 is a diagram showing an example of disassembly and disassembly cost management flow according to an embodiment of the invention.

FIG. 23 is a diagram showing an example of collection, disassembly acceptance and disassembly management flow in a reception management center management system according to an embodiment of the invention.

FIG. 24 is a diagram showing an example of recycling cost, collection cost and disassembly cost management flow in the reception management center management system according to an embodiment of the invention.

FIG. 25 is a diagram showing an example of a collection application product status check screen according to an embodiment of the invention.

FIG. 26 is a diagram showing an example of a collection application product status check flow according to an embodiment of the invention.

FIG. 27 is a diagram showing an example of a recycle rate management database according to an embodiment of the invention.

FIG. 28 is a diagram showing an example of recycle rate computation flow according to an embodiment of the invention.

FIG. 29 is a diagram showing the selection of a corresponding period for recycle rate computation according to an embodiment of the invention.

FIG. 30 is a diagram showing an example of a recycle rate management database including subcontractors according to an embodiment of the invention.

FIG. 31 is a diagram showing an example of recycle rate computation flow comprising subcontractor results according to an embodiment of the invention.

FIG. 32 is a diagram showing an example of a database relating to product parts re-use according to an embodiment of the invention.

FIG. 33 is a diagram showing an example of product parts re-use management flow according to an embodiment of the Invention.

FIG. 34 is a diagram relating to an instruction screen or document according to an embodiment of the invention.

FIG. 35 is a diagram showing an example of management information backup by a collection company according to an embodiment of the invention.

FIG. 36 is a diagram showing an example of the flow of management information backup by the collection company according to an embodiment of the invention.

FIG. 37 is a diagram showing an example of a management information backup screen from the collection company according to an embodiment of the invention.

FIG. 38 is a diagram showing an example of overall operation and processing flow according to another embodiment of the invention.

FIG. 39 is a diagram showing an example of flow relating to extraction of re-use products at a parts collection center according to an embodiment of the invention.

FIG. 40 is a diagram showing an example of process flow relating to delivery of re-use parts at the parts collection center according to another embodiment of the invention.

FIG. 41 is a diagram showing an example of a parts center system construction and process flow according to another embodiment of the invention.

FIG. 42 is a diagram showing an example of process flow in re-use parts management at the reception management center according to another embodiment of the invention.

DESCRIPTION OF THE PREFERRED EMBODIMENTS

Some embodiments of the invention will now be described based on the appended drawings.

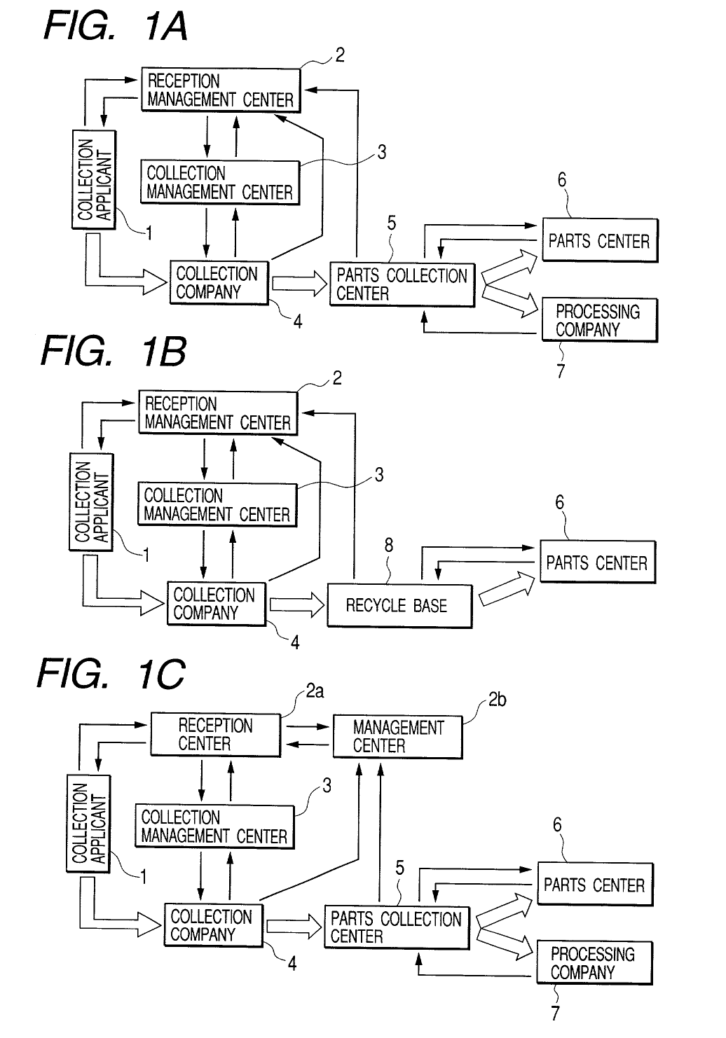

FIG. 1 shows the overall construction of the system of the invention.

As shown in FIG. 1A, the system comprises a reception management center 2 which exchanges information with a collection applicant 1 and performs information management, a collection management center 3 which manages collection information based on collection request information transmitted by the reception management center 2, a collection company 4 which performs collection and delivery based on the collection management information of the collection management center 3, a parts collection center 5 which salvages products and parts which could be re-used from collected products delivered by the collection company 4, a parts center 6 which acquires products and parts which could be re-used from the parts collection center 5, and a processing base 7 which performs processing which is essentially material recycling for parts which could not be re-used by the parts collection center 5. However, these centers and bases do not necessarily have the arrangement shown in FIG. 1A, and the centers and bases which perform the above operations may for example be implemented in the form shown in FIG. 1B. In this case, there is no difference regarding information categories except that insofar as concerns the detail of the embodiments of the invention shown below, there is a recycle base 8 which performs the work of the parts collection center 5 and processing base 7, and the other parties which exchange information with these centers and bases are different. In this case, the recycle base 8 has the functions of both the parts collection center 5 and processing base 7 and the work performed by the two centers/bases is then performed by one base, but identical elements are required for information exchange to those shown in FIG. 1A. It is also for example possible to separate the functions of the reception management center into reception functions and management functions, as shown in FIG. 1C, and have a reception center 2a and management center 2b operating as separate entities. In this case also, the management information is identical. Of the information which is managed in the reception management center 2, as regards information required for reception functions and management functions, a function is added for sending and receiving between the reception center 2a and management center 2b (this function can be implemented by an identical communication function to those between the other centers/bases), while regarding information categories which are sent and received by the reception management center 2 between the other centers/bases, the reception center 2a performs sending and receiving as regards reception functions, and the management center 2b performs sending and receiving as regards management functions. In the following patent, it will be assumed that all information is exchanged in the form of electronic data via the Internet or an intranet, but the same information categories may also be exchanged by another communication means such as telephone or fax, and the information transmission means do not limit the scope of this patent in any way. However, the information required to manage the reception management center management system 11 must finally be recorded as electronic data, and as for information categories transmitted by telephone or fax, it is assumed that these must be converted to an electronic format by the centers/bases which receive them or perform subsequent processing.

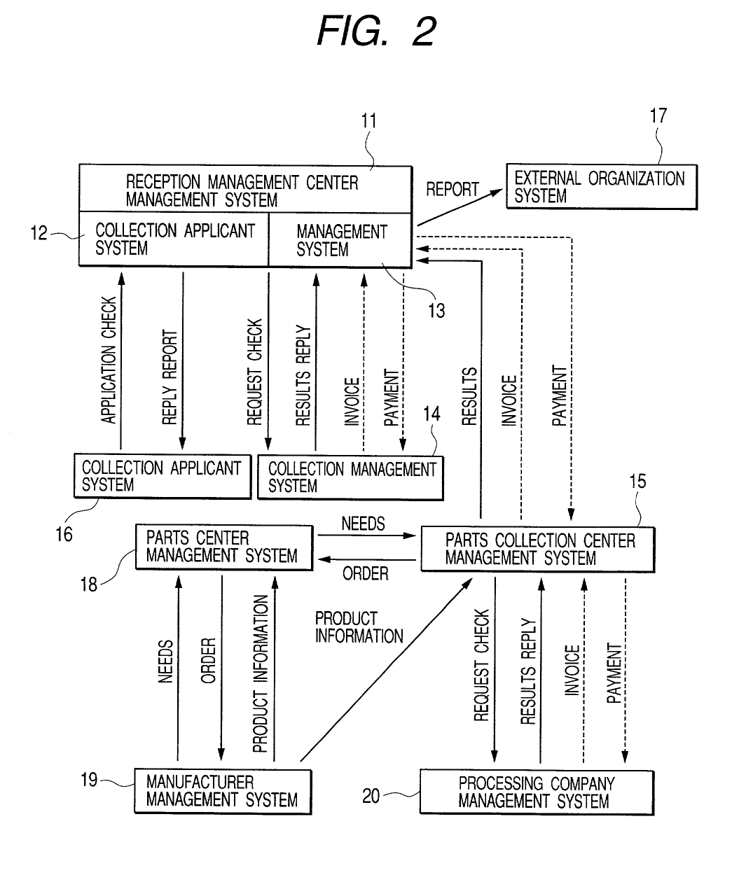

FIG. 2 shows the functions of the invention. The reception management center management system 11 comprises a collection applicant system 12 and management system 13. The collection applicant system 12 handles screens and receives input from collection applicants, manages output information and performs communication. The management system 13 receives information from peripheral systems, manages various types of information relating to collection application, and generates and transmits instructions to peripheral management systems. A collection management system 14 receives and manages information required to manage the collection, delivery and recycle cost of collection application items, and generates and transmits information. A parts collection center management system 15 receives information from peripheral systems, receives and manages information required for disassembly acceptance of collection items, determination of disassembly methods, disassembly, disassembly cost and management of recycle rates, and generates and transmits information. A collection applicant system 16 displays input screens for various information transmitted from the reception management center management system 11, inputs information and transmits the input information. An external organization system 17 manages, determines and discloses information sent from the reception management center management system 11. A parts center management system 18 receives information from peripheral systems, collects, accumulates and issues products/parts needs, and manages re-use products/parts orders and re-use products/parts costs. A processing company management system 20 manages recycle results in a yard by receiving information from peripheral systems, accepting material recycle parts, and managing the processing and dispatch of valuable or discarded items, and generates and provides recycle rate figures using this data.

These systems are not necessarily independent apart from the collection applicant system 12, for example, the reception management center management and system 11 and collection management system 14 may form one system. Moreover, it is not necessary to provide all the systems given here, it being sufficient to implement some of them.

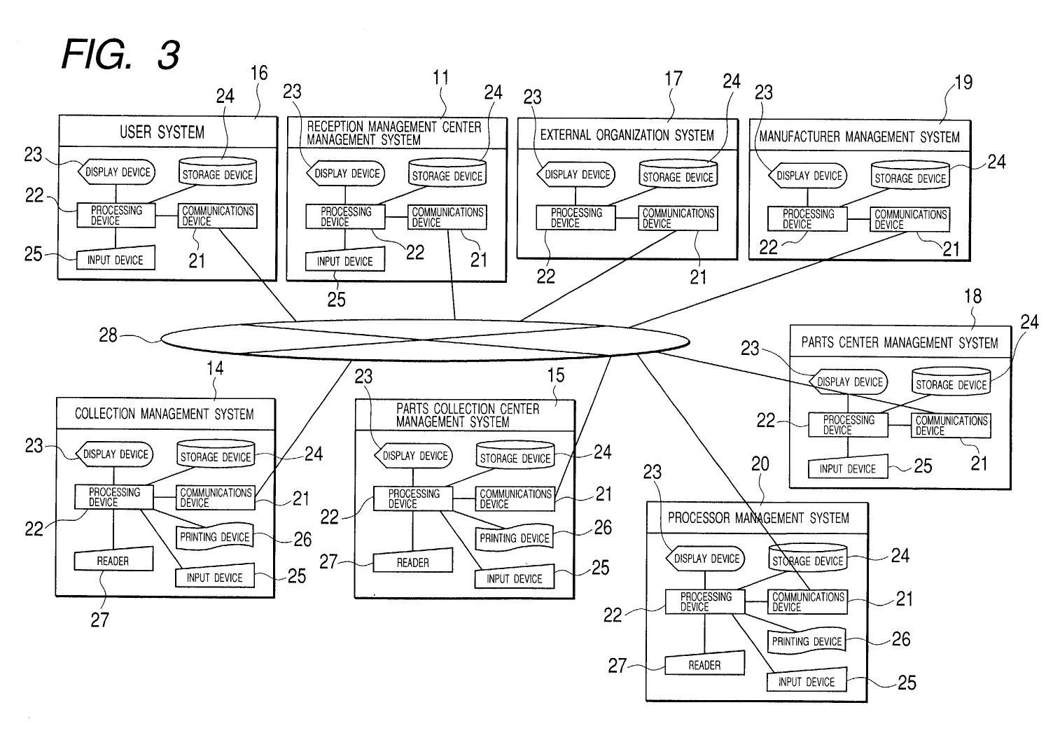

FIG. 3 shows the hardware construction of the invention. The system comprises the reception management center management system 11, collection management system 14, parts collection center management system 15, collection applicant system 16, external organization system 17, parts center management system 18, manufacturer management system 19, processing company management system 20, and a network 28 which connects these systems. The reception management center management system 11 comprises a communications device 21 such as a network device or modem, a processing device 22 such as a personal computer or central processing unit contained therein, a display device 23 such as a monitor, a storage device 24 such as a memory or hard disk, and an input device 25 such as a keyboard or mouse. The collection management system 14 comprises the communications device 21 such as a network device or modem, the processing device 22 such as a personal computer or central processing unit contained therein, the display device 23 such as a monitor, the storage device 24 such as a memory or hard disk, the input device 25 such as a keyboard or mouse, a printing device 26 such as a printer, and a reader 27 which can read a bar code, IC chip or the like. The parts collection center management system 15 comprises the communications device 21 such as a network device or modem, the processing device 22 such as a personal computer or central processing unit contained therein, the display device 23 such as a monitor, the storage device 24 such as a memory or hard disk, the input device 25 such as a keyboard or mouse, the printing device 26 such as a printer, the reader 27 which reads a bar code or IC chip or the like, and a weighing device 29. The collection applicant system 16 comprises the communications device 21 such as a network device or modem, the processing device 22 such as a personal computer or central processing unit contained therein, the display device 23 such as a monitor, the storage device 24 such as a memory or hard disk, and the input device 25 such as a keyboard or mouse. The external organization system 17 comprises the communications device 21 such as a network device or modem, the processing device 22 such as a personal computer or central processing unit contained therein, the display device 23 such as a monitor, and the storage device 24 such as a memory or hard disk. The parts center management system 18 comprises the communications device 21 such as a network device or modem, the processing device 22 such as a personal computer or central processing unit contained therein, the display device 23 such as a monitor, the storage device 24 such as a memory or hard disk, and the input device 25 such as a keyboard or mouse. The manufacturer management system comprises the communications device 21 such as a network device or modem, the processing device 22 such as a personal computer or central processing unit contained therein, the display device 23 such as a monitor, the storage device 24 such as a memory or hard disk, and the input device 25 such as a keyboard or mouse. The processing company management system 20 comprises the communications device 21 such as a network device or modem, the processing device 22 such as a personal computer or central processing unit contained therein, the display device 23 such as a monitor, the storage device 24 such as a memory or hard disk, the input device 25 such as a keyboard or mouse, the printing device 26 such as a printer, and the reader 27 which can measure the weight of items entering or leaving the warehouse.

In FIG. 3, these various systems are connected by the network 28, but it is not necessary that these be connected by an ordinary network such as the Internet. For example, identical results can be obtained by a communications means such as telephone or fax, or by sending a storage medium such as a floppy disk which can be read by the processing apparatus 22 from the originator to the recipient of the information.

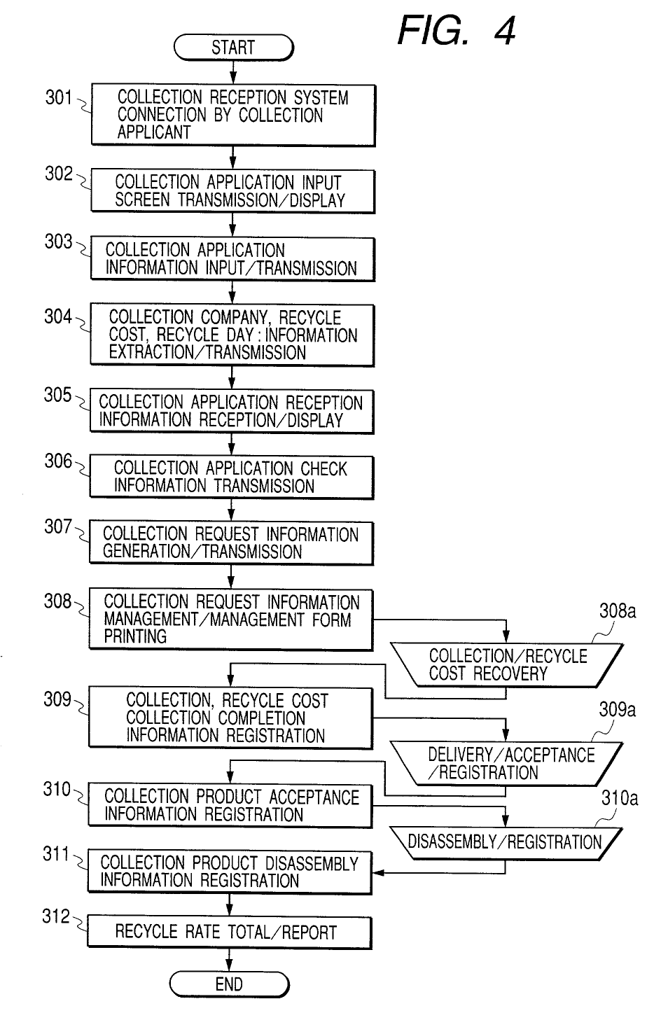

The overall flow in the invention will now be described referring to FIG. 1, FIG. 2, FIG. 3 and FIG. 4.

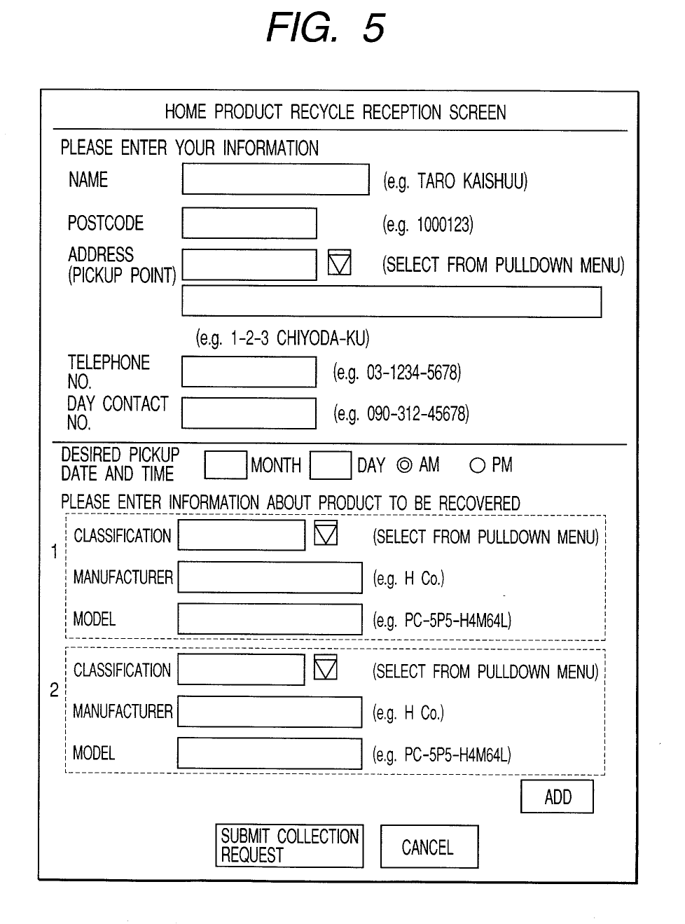

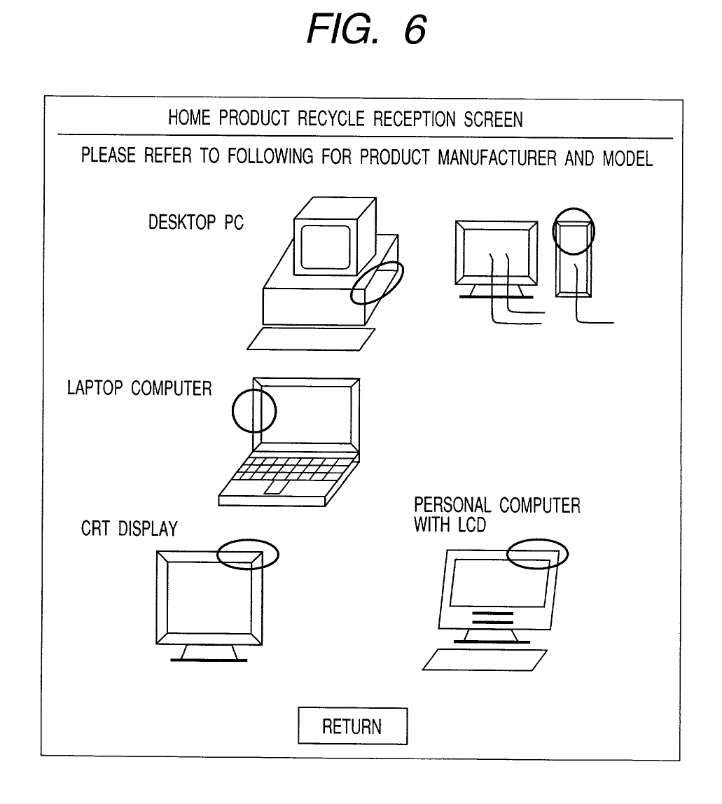

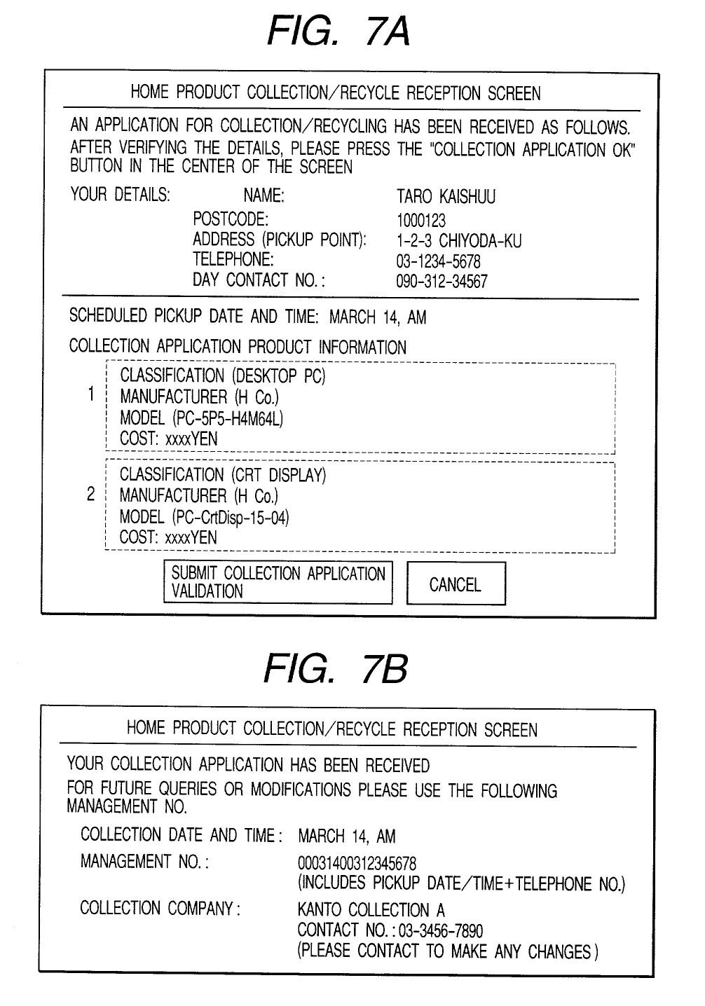

The collection applicant connects to the collection application system 12 in the reception management center management system 11 via the network 28 by means of the collection applicant system 16 (step 301). This connection may be identical to an ordinary Internet connection. However, the network 28 may also be realized by another means such as telephone or fax, and the same result can be achieved by inputting information to the reception management center management system 11 in the reception management center 2 based on this information. The collection applicant system 12 transmits a collection application input screen, whereof an example showing the necessary input categories is illustrated in FIG. 5, to the collection applicant system 16 via the network 28, and the collection applicant system 16 displays this on the display device 23 (step 302). This method is identical to that of an ordinary Internet connection, for example, an input screen whereof an example is shown in HTML format can be generated, and transmitted. The collection applicant inputs the name, collection pickup location, contact information and classification or model of the home products to be collected via the input device 25 using the collection application input screen, and transmits this information (step 303). This method may also be identical to that of an ordinary Internet connection. Here, regarding items which are difficult for the collection applicant to know, for example input information such as the model of a home product, it is convenient to show by means of figures or letters where model information is displayed for each product, as shown in the example of FIG. 6. The reception management center management system 11 receives the collection application information transmitted by the collection applicant system 16, 7 stores and manages this in the storage device 24, specifies the collection company which has been requested to collect the items from the pickup location in this information, specifies the recycle cost from the collection application classification, generates a collection application reception screen of which an example is shown in FIG. 7, and returns this information to the collection application system 16 via the network 28 (step 304). The collection application reception information received by the collection applicant system 16 displays the received collection application reception information on the display device 23 (step 305). This function can be implemented by an ordinary Internet function. By transmitting information comprising the cost of recycling or scheduled collection company on this screen, an estimate can be made for the collection application. A function is also provided to transmit collection application verification information, and when this function is implemented by the input device 25 such as a mouse, the collection application information verification information is transmitted (step 306). This function can also be implemented by an ordinary Internet function. This is made clearer if a final check is performed by transmitting a collection application confirmation reception check screen as shown in FIG. 7B. By adding the name of the collection company and its contact information, it is possible to deal with the case where, for example, the collection applicant wishes to change the collection date.

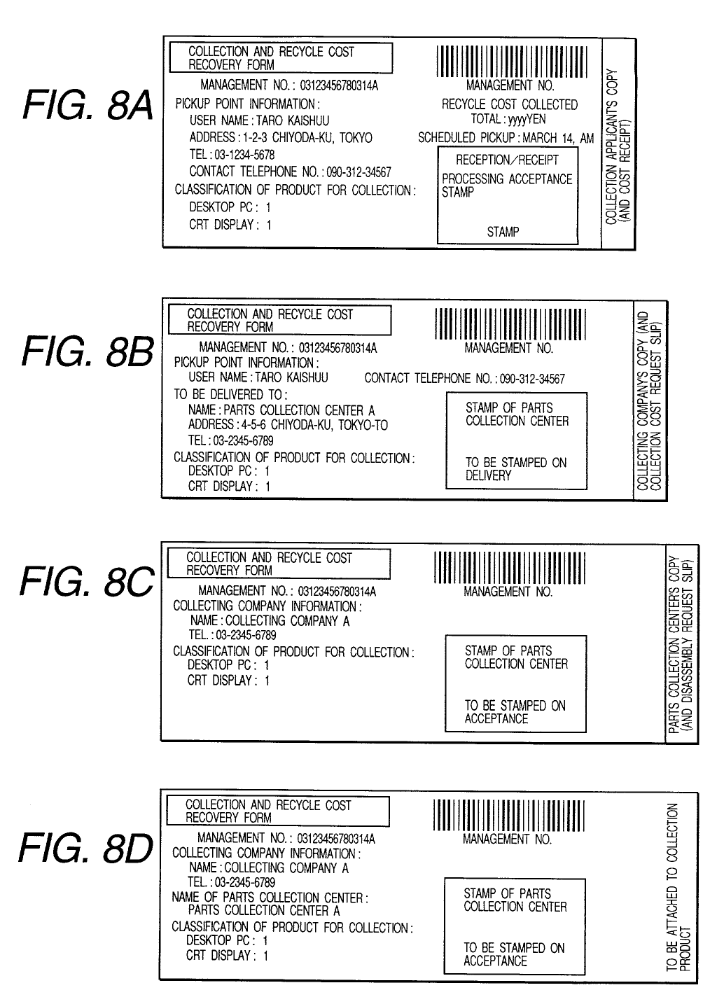

Using the collection application confirmation information transmitted in the step 306, by means of the collection application information input and transmitted in the step 303 or collection company information extracted in the step 304, collection request information such as collection applicant information, collection application item information and recycle cost information can be generated and transmitted to the collection management system 14 of the collection company extracted in the step 304 via the network 28 (step 307). Telephone or fax can also be used instead of the network 28. The collection company manages the collection request information transmitted by the collection management system 14, and prints a collection and recycle cost recovery form whereof an example is shown in FIG. 8 on the printing device 26 (step 308). The collection and recycle cost recovery form may be generated using information sent by the network 28, or by telephone and fax, and it is not absolutely necessary to use the collection management system 14.

Based on the collection and recycle cost recovery form, the collection company collects the collection application items from the collection applicant (step 308a). At this time, the recycle cost written on the collection and recycle cost recovery form is recovered if necessary, and part of the collection and recycle cost recovery form is given to the collection applicant as proof of collection and receipt for the recycle cost. It is desirable that the collection and recycle cost form bears the seal of the collection company. After collection/recycle cost recovery is complete, the collection company inputs the management number, collection complete and, if necessary, recycle cost recovery complete information to the collection management system 14, and manages it (step 309). This information is transmitted to the reception management center management system 11 via the network 28, and managed.

After performing ordinary delivery operations such as initial storage and packing if necessary, the collection company delivers the collection application items to the parts collection center 5. Here, the parts collection center 5 manages acceptance of the collection application items, and by registering them in the parts collection center management system 15 (step 309a) by reading or manually inputting management number information recorded using a barcode or the like on the collection and recycle cost recovery form when the collection application items are accepted, transmits this collection application item acceptance information to the reception management center management system 11 via the network, and manages it (step 310).

Based on product re-use item needs information and product information from the manufacturer management system 19, when the collection application items are disassembled, the parts collection center 5 manages the disassembly of the collection application items by reading the management number information of the collection and recycle cost recovery form attached to the collection application items and registering it in the parts 3 collection center management system 15 (step 310a), transmits this collection application item processing information to the reception management center management system 11 via the network, and manages it (step 311). In some cases however, it may not be absolutely necessary to transmit this collection application item disassembly information to the reception management center management system 11, and manage it.

When the collection application items are disassembled (step 310a), the parts collection center 5 manages the recycle rate, and after collecting this information, it transmits it to the reception management center system 11 from the external organization system 17 via the network 28 or by telephone or fax, and makes a report (step 312).

In the above description, the collection applicant is normally the owner or user of personal home products (in the case of a business, this is normally the person in charge of the organization using the devices), the collection company is a waste material transport company or home parcel delivery transport company, the parts collection center is an organization or business having the ability to verify collection application items and extract components with a view to re-use of products and parts, and the processing company is an intermediate processing company such as a disassembly company, the reception management system being managed by any of these or by another organization.

Here, the method of the step 304 will be described in detail.

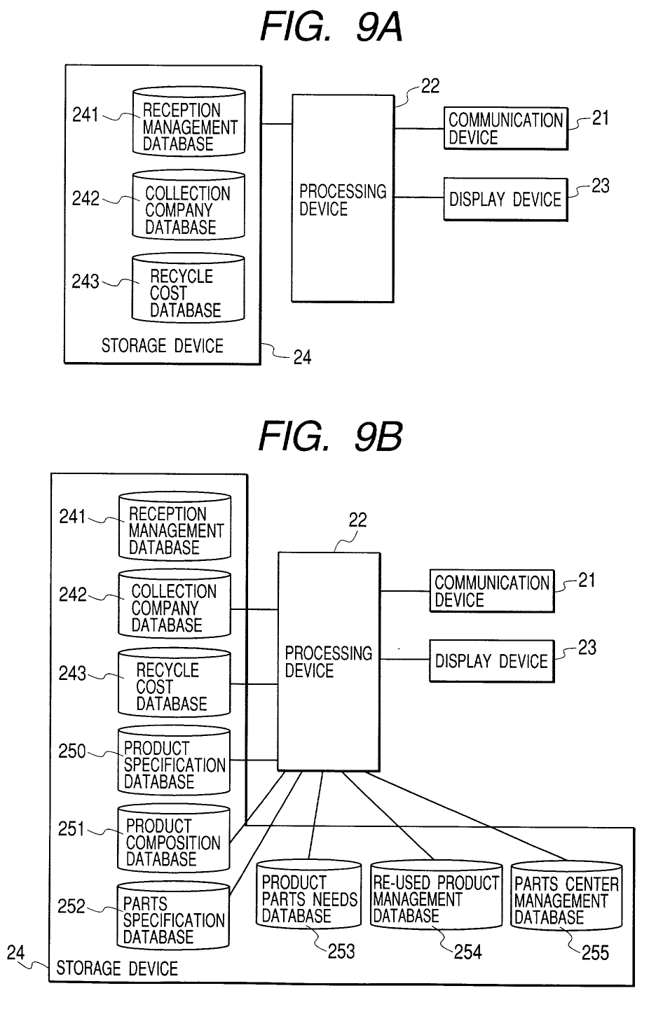

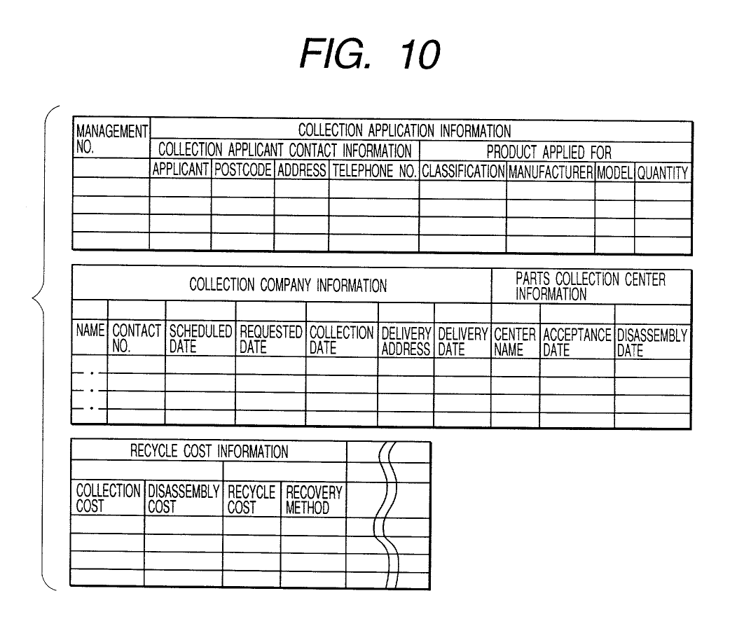

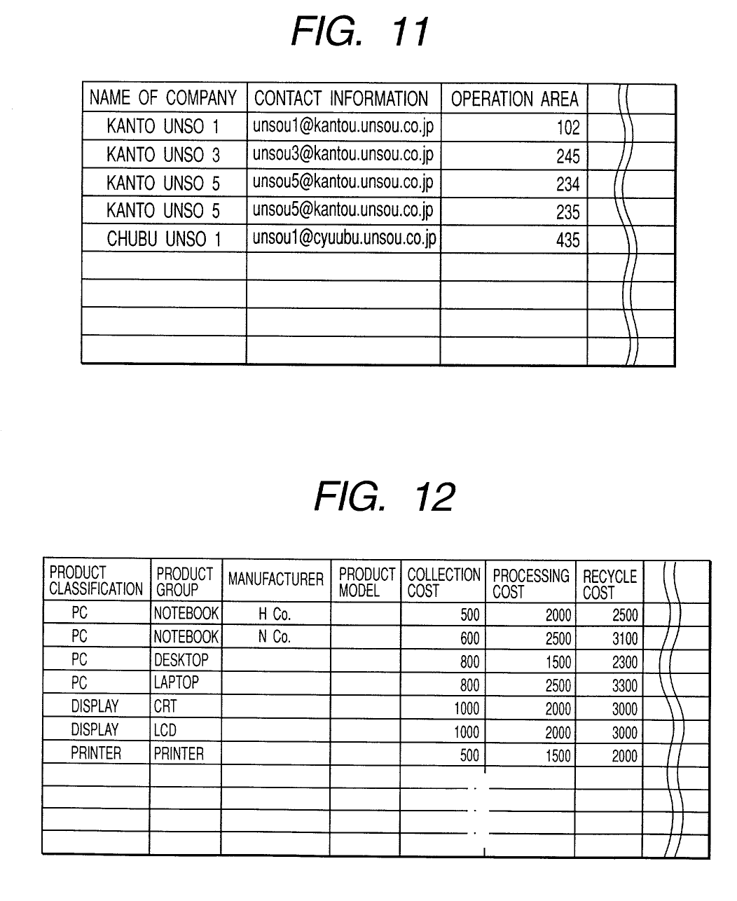

The detailed construction of the reception management center management system 11 is shown in FIG. 9A. The storage device 24 manages a reception management database 241 whereof an example is shown in FIG. 10, collection company database 242 whereof an example is shown in FIG. 11, and a recycle cost database 243 whereof an example is shown in FIG. 12. Here, the reception management database 241 manages information such as the management number, name of the collection applicant, contact information, pickup location, collection application item classification, collection application item quantity, recycle cost recovery payment method, recycle cost estimate, name of scheduled collection company, and the collection request state, scheduled collection date, collection date, name of parts collection center, acceptance date, disassembly date, collection cost and disassembly cost. The collection company database 242 manages information such as the collection company name, contact information and area of operation. The recycle cost database 243 manages information such as product classification (personal computer) or product type (desktop computer), information required for distributing recycle costs according to manufacturers and product models, collection cost and disassembly cost, and the recycle cost which is the sum total of all of these. There may also be other information. Further, of the above information, some of the information such as collection dates and manufacturers may not be absolutely necessary in the step 304.

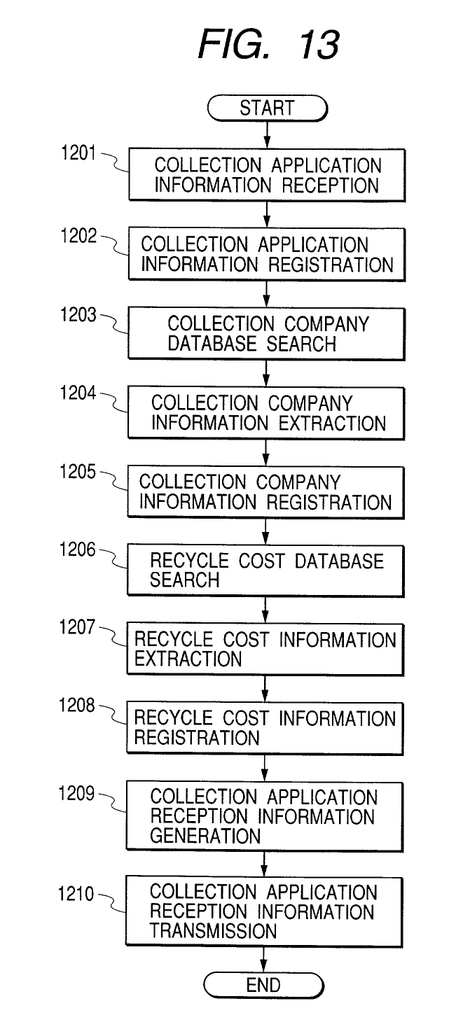

FIG. 13 shows the steps in the system which generate and transmit the collection application reception information which is taken in to the processing device 22 of the reception management center management system 11. The collection application information sent by the collection applicant system 16 is received by the communications device 21, and transmitted to the processing device 22 (step 1201). In a step 1202, the collection application information received in the step 1201 is registered in this information category in the reception management database 241.

This means is identical to the method performed by an ordinary database management system. Next, in the step 1203, the collection company database 242 is searched by the pickup location (e.g., postcode) of the collection applicant received in the step 1201. For example, if the postcode is managed as information about the range of pickup locations for which the company is responsible in the database 242, a search can be performed from the pickup location information received in the step 1201. Regarding this search means, a search method such as perfect match, front agreement and minimum agreement which are ordinarily used as database search means, may be used. Next, based on the database search results of the step 1203, information such as the collection company name and collection company contact information are acquired in a step 1204, and registered in the reception management database 241 (step 1205). Next, in a step 1206, from the collection application item information (for example, collection item classification, collection item manufacturer and collection item model) for the collection applicant received in the step 1201, the recycle cost database 243 is searched. In a step 1207, the recycle cost (collection cost, disassembly cost) is extracted for categories which match in the step 1206, and registered in the reception management database 241 (step 1208). This search/extraction method is identical to the ordinary database search/extraction method described earlier, but in this search, priority is given to finer data division. For example, by preferentially searching the model, product group and product classification, the recycle cost can be extracted for a particular product model in the same product classification. Next, collection application information is generated from information extracted in the step 1204 and the step 1207 (step 1209), and transmitted to the collection applicant system 16 which made the collection application (step 1210). The collection application information may be the collection categories shown in FIG. 7. For example, the scheduled collection date information is the shortest number of days in which collection is possible by adding a number of days specified by the system to the collection application date acquired in the step 1201, the date matching the desired collection date thus acquired in the step 1201 being the scheduled collection date (e.g., a certain specified date or day of the week). Regarding recycle cost, the cost extracted in the step 1207 can be used. This may for example be generated in HTML format used by an Internet Web browser.

Next, the method of the step 307 will be described in detail.

The reception management center management system 11 is that described in detail in the step 304.

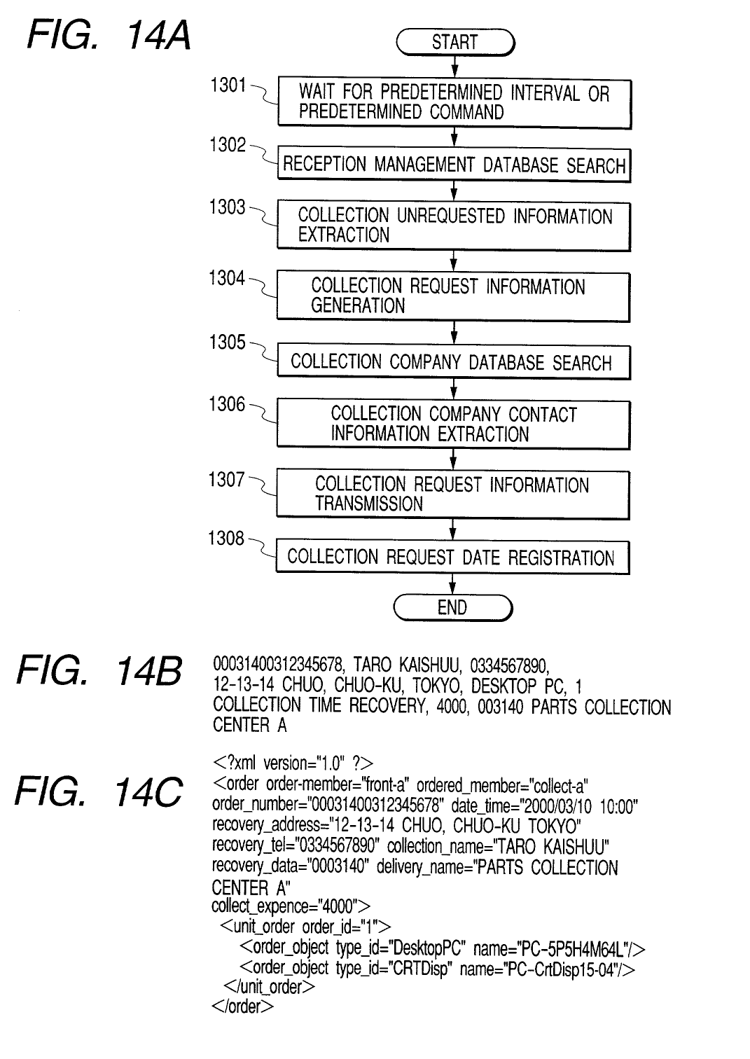

FIG. 14A shows the steps of the system which generate/transmit collection request information introduced into the processing device 22 of the reception management center management system 11.

Regarding information about a collection application, as a collection request is made at a predetermined interval or according to the intention of the operator of the reception management center, the execution of a predetermined command at a preset interval or time, or from the keyboard or mouse, is awaited (step 1301). This may for example be incorporated in a batch program which starts automatically at a certain time, or a program which starts automatically at a predetermined interval, and which may contain a command implementing this function. Next, the reception management database 241 is searched (step 1302), and information is extracted for which application information such as the name of the collection applicant is registered, but the collection request date is not registered (step 1303). When a collection application has been made but a collection request has not yet been made, collection request information is generated comprising the management number, name of the collection applicant, contact information, pickup location, collection application item type, collection application item quantity, recycle cost payment method, recycle cost estimate, scheduled collection date and name of parts collection center to which the items are to be delivered (step 1304). Next, the collection company database 242 is searched by the name of the collection company relating to this information (step 1305), the contact location of the collection company is extracted (step 1306), and the collection request information generated in the step 1304 is transmitted (step 1307). The completion of the collection request relating to this collection application information is managed by registering the date on which the collection request information was transmitted in the reception management database 241 (step 1308). The data registered in the step 1308 is not necessarily the collection request date, and may be a flag or the like indicating that transmission of the information is complete.

Here, the collection request information may be generated in a predetermined written format (e.g., sequence or pause characters) required by the collection request, as shown in FIG. 14B, or by combining information categories with character strings in the contents required by the collection request, whereof an example is shown in FIG. 14C. This information may be exchanged based on predetermined rules between the reception management center management system 11 and collection management system 14, and is not limited to a written format.

Here, from the step 1302 to the step 1303 in FIG. 14A, information for which the collection request date has not yet been registered comprises categories other than recovery by the collection company, such as when the recycle cost recovery payment is paid in advance. If only information for which the recycle cost recovery date has been registered is extracted, as for collection application information wherein the recycle cost is recovered in advance, a collection request can be made without fail after the recycle cost has definitely been recovered, thus preventing leakage of recycle cost recoveries. In this case, concerning recycle cost estimates for collection request information generated in the step 1304, double invoicing of the recycle cost can be avoided by marking 0 yen or “received” on the recycle cost estimate.

Next, the method of the step 308 will be described in detail.

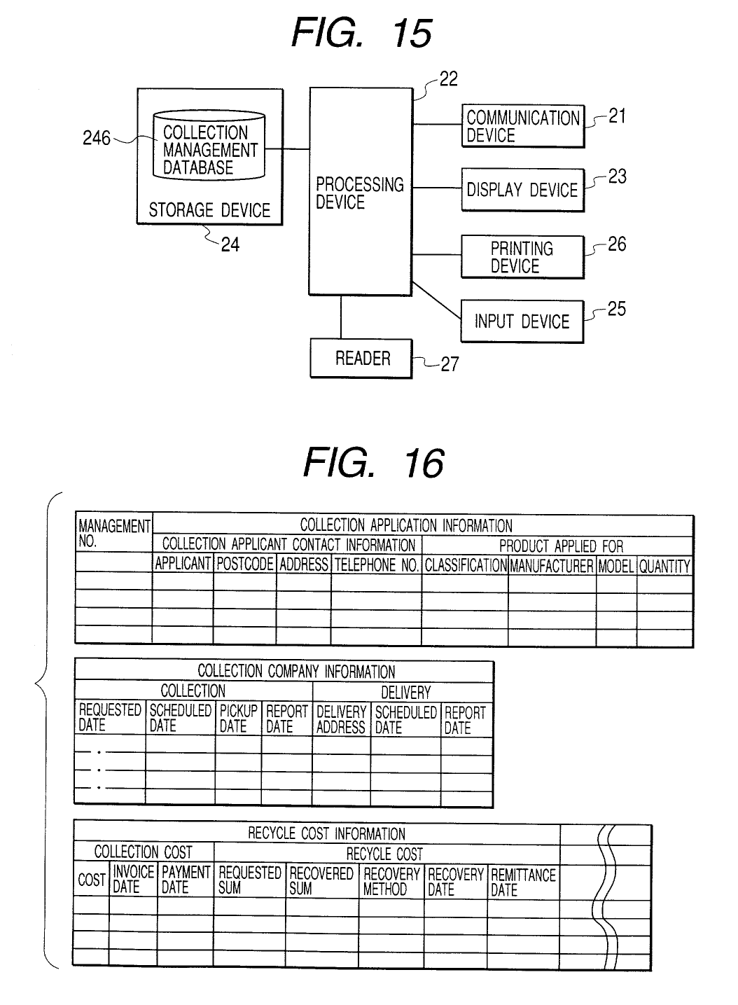

The detailed system construction of the collection management system 14 is shown in FIG. 15. The storage device 24 manages the collection management database 246 whereof an example is shown in FIG. 16. The collection management database 246 manages collection application information such as the management number, collection applicant name, contact information, pickup location, collection application item type and collection application item quantity, and collection request information such as recycle cost estimate, recycle cost recovery method, scheduled collection date, name of parts collection center to which delivery is scheduled and collection request date. There may be other information in addition to this information.

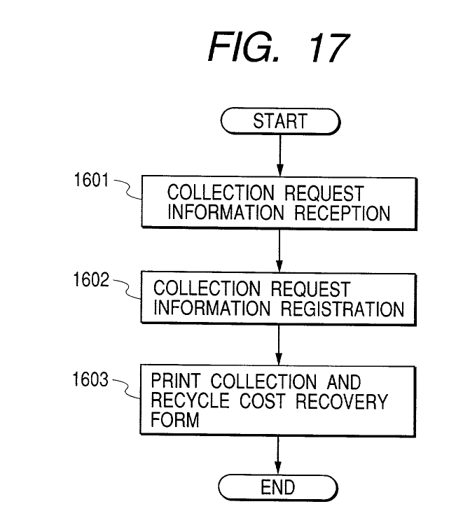

FIG. 17 shows the processing steps of the collection management system built into the processing device 22 of the collection management system 14. The collection request information sent (step 307) from the reception management center management system 11 is received by the communications device 21, sent to the processing device 22 (step 1601), and registered in the appropriate information category of the collection management database 246 (step 1602). The reception of information and registration in the databases is identical to present communication and database management methods. Next, based on the collection application information received in the step 1601, the collection and recycle cost recovery form whereof an example is shown in FIG. 8 is printed by the printing device 26 (step 1603). However, this collection and recycle cost may also be generated by displaying information received in the step 1601 on the display device 23, and performing manual operations on this information.

In the step 1603, when for example the recycle cost recovery method specified recovery other than at the time of collection, such as recovery in advance, a clear distinction can be made between advance recovery of recycle cost and recovery on collection by displaying 0 yen for the recovery recycle cost.

Next, the collection and recycle cost recovery form, whereof an example is shown in FIG. 8, will be described in detail. For the purposes of management, described hereafter, it is convenient if the collection and recycle cost recovery form has details which can easily be read by the reader 27 such as a barcode representation of the management number (not necessary when the management number can be easily read by the reader 27), collection applicant contact information, scheduled collection date, collection item type, recycle cost and a column for stamping the recycle cost receipt, the first copy (FIG. (8a)) for example being the collection applicant's copy, the second copy (FIG. 8B) being the collection company's copy, the third copy (FIG. 8C) being the disassembly company's copy, and the fourth copy (FIG. 8D) being attached to the item itself. The various categories do not necessarily have to be marked on all the copies, and for example the parts collection center copy does not have to contain information such as the collection applicant's contact details. Also, by providing a column for stamping to confirm reception/receipt/processing transfer on the collection applicant's copy form, reception and receipt of the recycling cost, and collection/recycle transfer by the collection/recycling system, can be validated which makes for clarification of recycling responsibilities.

In FIG. 8B, information regarding the delivery location was shown as an address or a name, but if this is limited for example to the code of the delivery center which manages the delivery location and the name of the delivery location, the address of the parts collection center to which the delivery is to be made can be specified without revealing it to other parties.

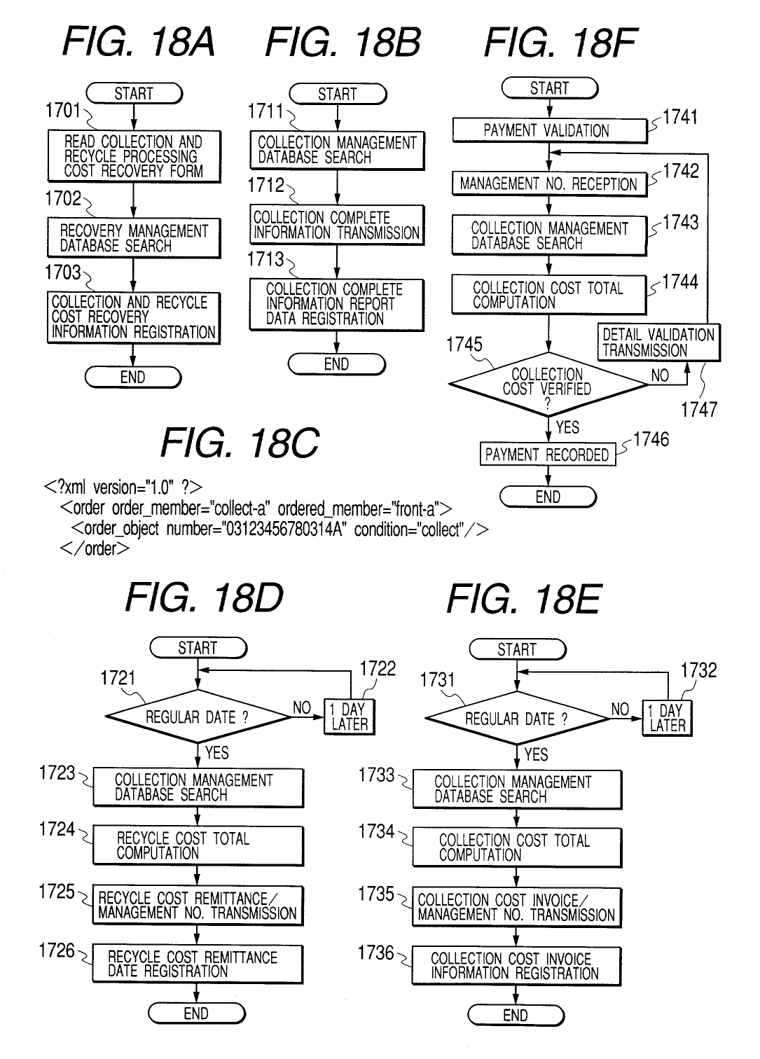

Next, the method of the step 309 will be described in detail referring to FIG. 18.

The collection company recovers the collection application items in the step 308a, and recovers the recycle cost if necessary. Here, the management number of the collection and recycle cost recovery form for the collection application item is read by the reader 27 (step 1701). The corresponding category of the collection management database 246 is searched (step 1702) using this management number, and concerning this collection application item, the collection date in the collection management database 246 and recycle cost recovery date of the recycle cost information are registered (step 1703) as collection and recycle cost recovery completion information. This database registering means may use ordinary database registering means. According to this method, the collection information pertaining to the collection application item can easily be managed. When the recycle cost is not recovered at the time of collection, the processing of the step 1703 may be considered as collection completion information, and the collection date in the collection management database 246 may be registered.

The collection management system 14 also performs operations at a predetermined interval of for example one day, or according to the intention of the operator of the collection management center, so the collection management database 246 is searched at a preset interval or time, or by a predetermined command such as from the keyboard or mouse, and information is extracted regarding items which have been collected (collection date is registered), but for which there is no report (collection report date is not registered) (step 1711). Concerning this collection application information, the collection date is transmitted together with the management number (step 1712), and the date is registered as collection date report information (step 1713). In this way, the collection management system 14 can register collection complete information in the reception management center management system 11. Here, the information transmitted in the step 1712 may be the collection company information and management number, or a flag showing that collection is complete, as shown in FIG. 18C.

If identical processing is performed for the delivery date (delivery date and delivery report date), the collection management system 14 and reception management center management system 11 can manage delivery complete information.

In the step 303, this collection recycle system performs subsequent collection/recycle management using collection application information such as the collection application item type, manufacture and model input by a collection applicant 1 on the screen whereof an example is shown in FIG. 5, however not all the information has to be input here, and it may occur that incorrect information is input. In the parts collection center management system 15, the operating details are determined using product model information as described later, and this information is extremely important for the system. Hence, a function is provided at the collection company 4, parts collection center 5 or recycle base 8 to make additions and corrections to collection item information such as collection application item type, manufacturer and model which are important for the operation of the collection recycling system.

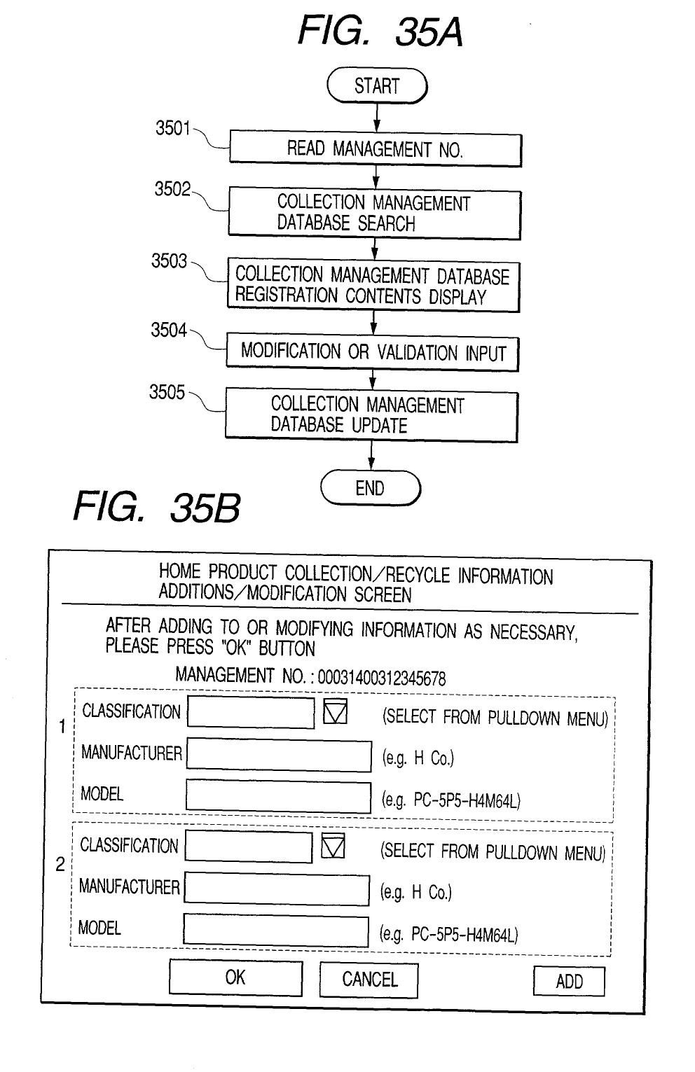

The method of making additions to the information will be described referring to FIG. 35. First, the management number attached to the collection item is read (step 3501), and the collection management database 246 is searched (step 3502). Here, information such as the collection application item type, collection application item quantity and collection application item model related to the collection application item having the management number recorded in the collection management database 246 is displayed on a screen whereof an example shown in FIG. 35B (step 3503). On this screen, if there are any discrepancies from the actual collection item or insufficient information, this information is input/corrected by the input device 25 (step 3504), and the collection management database 246 is updated using this information (step 3505). In the step 3505, the date of collection and the date of recycle cost recovery performed in the step 1703 are also registered. According to this method, the collection company 5 can easily manage collection information for the collection application item, correctly modify information relating to the collection item, and smoothly perform subsequent collection/recycling. If the recycle cost is not recovered at the time of collection, registration of the recycle cost recovery date in the processing of the step 3505 is unnecessary.

Here, additions and corrections in the collection management system 14 of the collection company 4 were taken as an example, but identical processing may be performed at other bases. For example, if additions and corrections are made by the parts collection center management system 15 of the parts collection center 5, the database intended by the step 3502, step 3503 and step 3505 is the processing management database 248, the remaining processing being identical.

When additions are made to the information in the collection management system 14, for example in the case of the product model, product model information of the product specification database 250 is searched using the input information, and if no corresponding model exists, additional information can be examined such as by suggesting re-input.

In this collection recycle system, a collection request comprising the management number is transmitted from the reception management center management system 11 to the collection management system 14 when there is such a collection request, and this is registered in the collection management database 246 in the collection management system 14. However, if this is not done for some reason, it is convenient if the collection management system 14 has an identical function to add information.

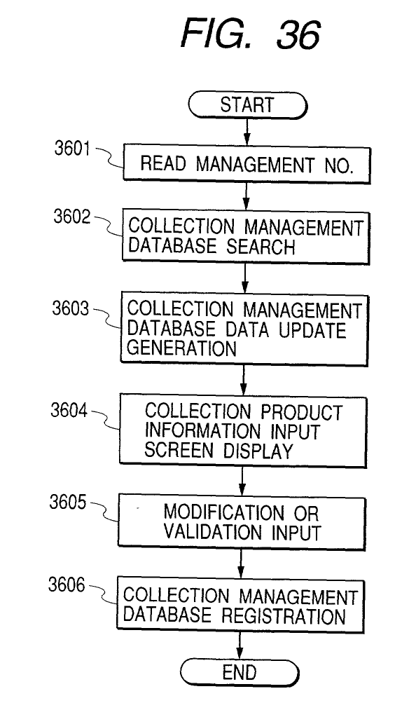

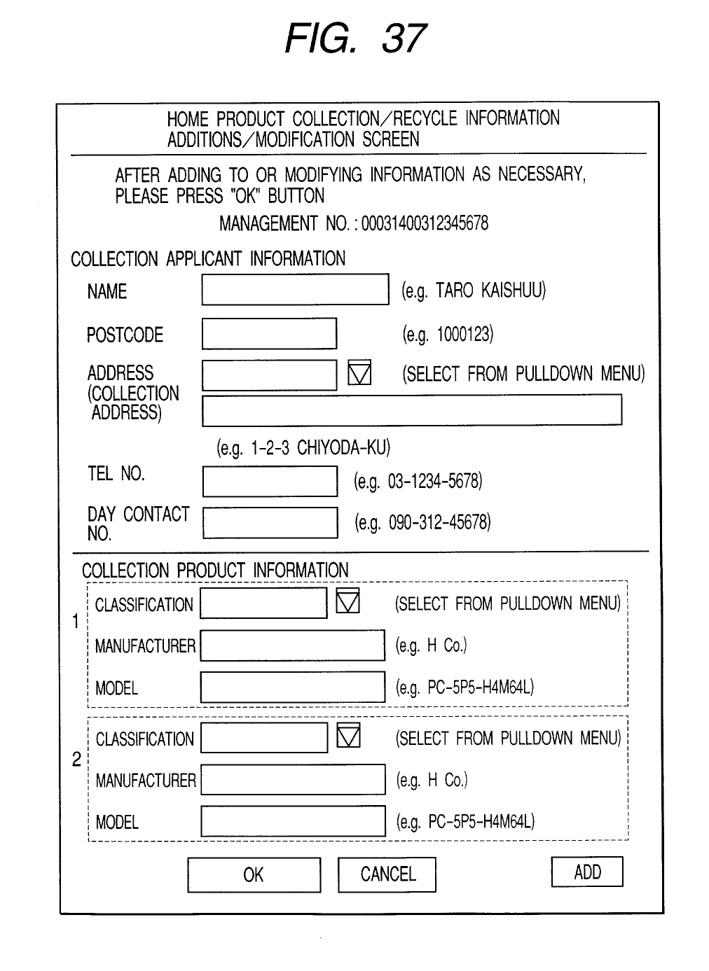

The method of adding information when a product having a management number not registered in the collection management database 246 is collected, will now be described referring to FIG. 36, FIG. 37. First, the management number attached to the collection item is read (step 3601), and the collection management database 246 is searched (step 3602). Here, if there is no corresponding management number in the collection management database 246, information for this management number is newly generated in the collection management database 246 (step 3603), the information input screen whereof an example is shown in FIG. 37 is displayed (step 3604), information relating to the collection item is input by the input device 25 on this screen (step 3505), and this is registered in the collection management database 246 using this information (step 3606). In the step 3606, the date of collection and recovery of recycling cost performed in the step 1703 are also registered. According to this method, the collection company 5 can easily manage collection information for the collection application item, correctly modify information relating to the collection item, and smoothly perform subsequent collection/recycling. If the recycle cost is not recovered at the time of collection, the registration of the recycle cost recovery date in the processing of the step 3606 is unnecessary. In the step 3505, it is not absolutely necessary to input all the information, and only the information to hand may be input.

Here, in the collection management system 14 of the collection company 4, an example was described where addition was performed, but identical processing may also be performed at other bases. For example, if additions and corrections are performed in the parts collection center management system 15 of the parts collection center 5, the database intended by the step 3602, step 3603 and step 3606 is the processing management database 248, the remaining processing being identical.

Here, when additions/modifications are made to the collection item information in the collection management system 14, when the collection management system 14 transmits the collection complete or delivery complete information described by FIG. 18B to the reception management center management system 11, in the step 1712, as regards this collection application information, the management number, collection date and additional information or all the information to which additions might be made in the collection management system 14 in the information having this management number recorded in the collection management database 246, is transmitted together, and as regards the collection item having this management number, information to which additions are made as described using FIG. 35, FIG. 36, FIG. 37 can be transmitted to the reception management center management system 11.

To optimize the transmitted information, in the collection management database 246, as regards information categories to which additions might be made in the collection management system 14, an addition flag is provided. For data categories which are registered or updated in the step 3505 or step 3606, this addition flag is activated, and when collection complete information is next transmitted in the step 1712, only information categories for which this addition flag is valid are simultaneously transmitted. By inactivating this addition flag, only necessary information need be transferred. Here, in the collection management system 14 of the collection company 4, the case of additions and modifications was described, but identical processing can be performed at other bases. For example, if additions/modifications are performed in the parts collection center management system 15 of the parts collection center 5, the database concerned is the processing management database 248, the remaining processing being identical.

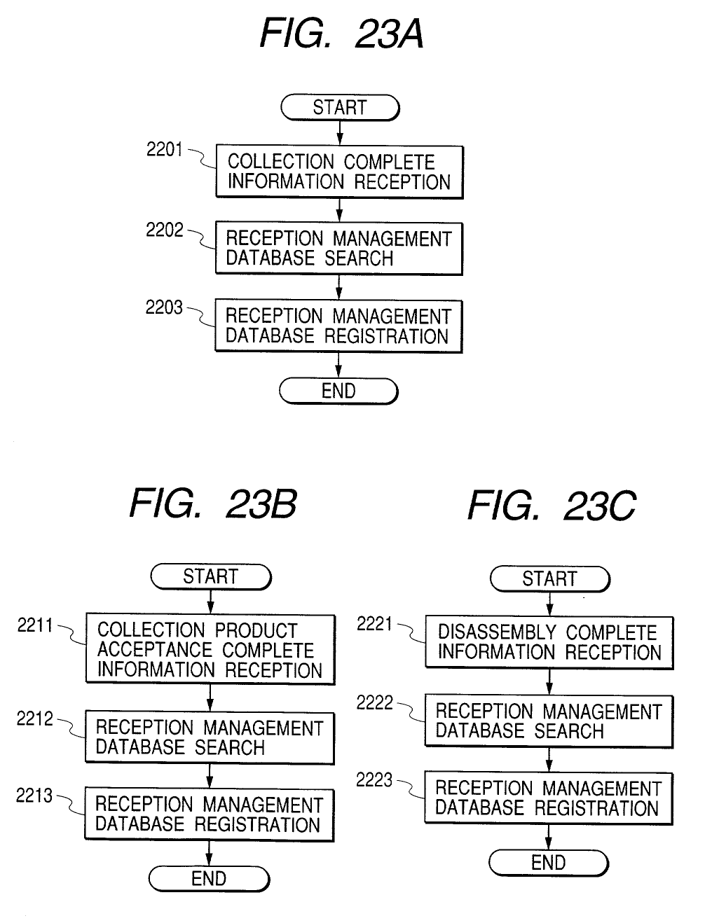

Here, in the reception management center management system 11, when additional information is transmitted, the additional information in the reception management database 241 is also registered in the step 2203, step 2213 and step 2223 shown in FIG. 23. The name of the parts collection center to which collection items having this management number are delivered is extracted, the contact information for this parts collection center is extracted from the collection company database 242, and the additional information is transmitted to the parts collection center management system 15 as scheduled delivery information together with the management number.

The parts collection center management system 15 can then search the processing management database 248 from the management number of the received information, and update the database using the scheduled delivery information sent in connection with this information.

Regarding data categories to which additions can be made in the reception management database 241, for example if there are several combinations of registration date, registering company and data, a data update log may be left by keeping plural updates of information such as the name of the party making registration/additions when data is registered or supplemented.

Further, the collection management system 14 searches information for which the recycle cost recovery date is registered for a predetermined period such as for example a specified date each month (step 1721, 1722), but a remittance date has not been registered (step 1723). For this collection application item information, the recycle cost recovery amount is totaled (step 1724), this sum is remitted/transmitted together with management number information (step 1725) by a method specified by the reception management center management system 11, and the remittance date information for this collection application item is registered (step 1726). In this way, the collection management center 14 entrusts management to the reception management center management system 11 for recycle costs which it has recovered. The transmission method in the step 1725 is identical to that shown in the step 1712, and the remittance method may be an identical means to that used for ordinary bank transfer. The recipient of the remittance may first be incorporated in the collection management system 14. In this method, the name of the bank (bank number), account type, account number and account name may for example be recorded under the name of the “recipient” in a setting file. In the above step 1722, in FIG. 18D, there is a waiting period of one day, but the sum can be remitted a certain number of days or on a certain date specified by the system such as after a waiting period of one week or ten days.

The recycle cost recovery sum is totaled in the step 1724, and this is transmitted as remittance information together with the management numbers which were totaled in the step 1725, but identical processing can be performed also when money is remitted/transmitted separately for each management number excepting that the step 1724 is unnecessary. This is the same for all remittance management methods described later.

The collection management system 14 searches collection application items for which collection and recycle cost recovery information, and remittance information, are registered, but the recovery cost has not yet been invoiced (this information is not registered) (step 1733) from the collection management database 246 at a fixed interval (e.g., every day, once every two days, once a week or once a month) (steps 1731, step 1732), and computes the total amount of recovery cost for this product (step 1734). In respect of this total amount, the corresponding recycle cost is invoiced (step 1735) by the predetermined method to the reception management center management system 11 together with the management number of the corresponding collection application item, and the date of invoicing the collection cost of this product is registered (step 1736). Hence, the collection management system 14 can invoice the recovery cost to the reception management center management system 11. Here, the transmission method of the step 1735 may be identical to the method shown in the step 1712.

In the step 1734, the collection cost invoice amount is totaled, and transmitted as invoice information together with plural management number information totaled in the step 1735, but identical processing can be performed even when invoicing is performed separately for each management number excepting that the step 1734 is unnecessary. This is identical for all fee invoicing management methods described later.

The collection management center 14 verifies the payment amount (step 1741) and management number (step 1742) for the collection cost sent together with transmission of the management number information from the reception management center management system 11, verifies this management number from the collection management database 246 (step 1743), computes the total amount of collection cost for this collection application item (step 1744), verifies whether the payment amount matches (step 1745), and if it matches, registers the payment information for the collection cost of the product having this management number (step 1746). When it does not match in the step 1745, a confirmation message is transmitted by information such as the corresponding management number and payment sum to the reception management center as regards the contents which do not match (step 1747), and collection cost payment processing is performed by repeating until the payment sum and total amount do match.

In the step 1741, identical processing may be performed also using remittance information from a financial institution which acquires the payment information.

In the aforesaid description, the remittance sum for each management number was totaled in the step 1744 using the management number of the transfer information corresponding to plural received management numbers, and it was verified whether this matched the payment amount in the step 1745, but when transfer is made separately for each management number, the step 1744 is unnecessary. This is identical for all fee payment confirmation management methods described later.

In the collection management center 14, in the processing of the aforesaid step 1721 to step 1726, step 1731 to step 1736, and step 1741 to step 1747, there is also a method where only the disassembly cost, obtained by subtracting the collection cost from the recovered recycle cost, is remitted to the reception management center management system 11, so that a sum equivalent to the collection cost is paid. In this case, in the aforesaid step 1724, the total amount of the cost obtained by subtracting the collection cost from the recycle cost (i.e., the disassembly cost) is used instead of the total amount of the recycle cost, and the disassembly cost remittance sum and collection cost payment can be registered in the step 1726. In this case, the steps of FIG. 18E to FIG. 18F are unnecessary.

Next, the method of the step 310 will be described in detail.

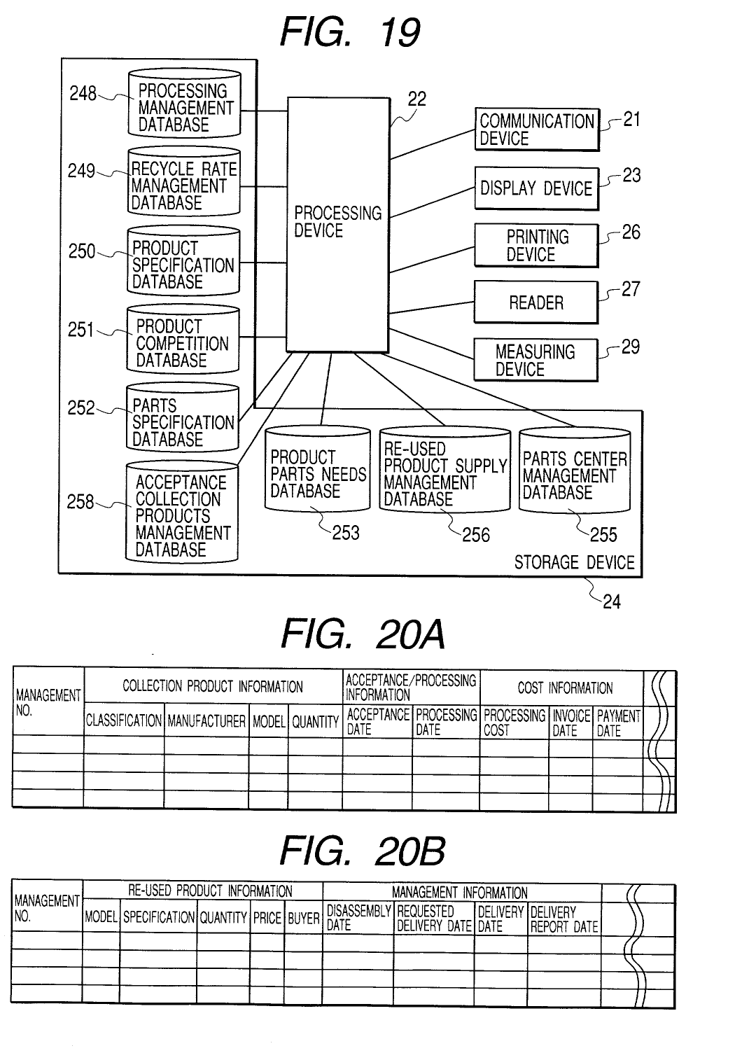

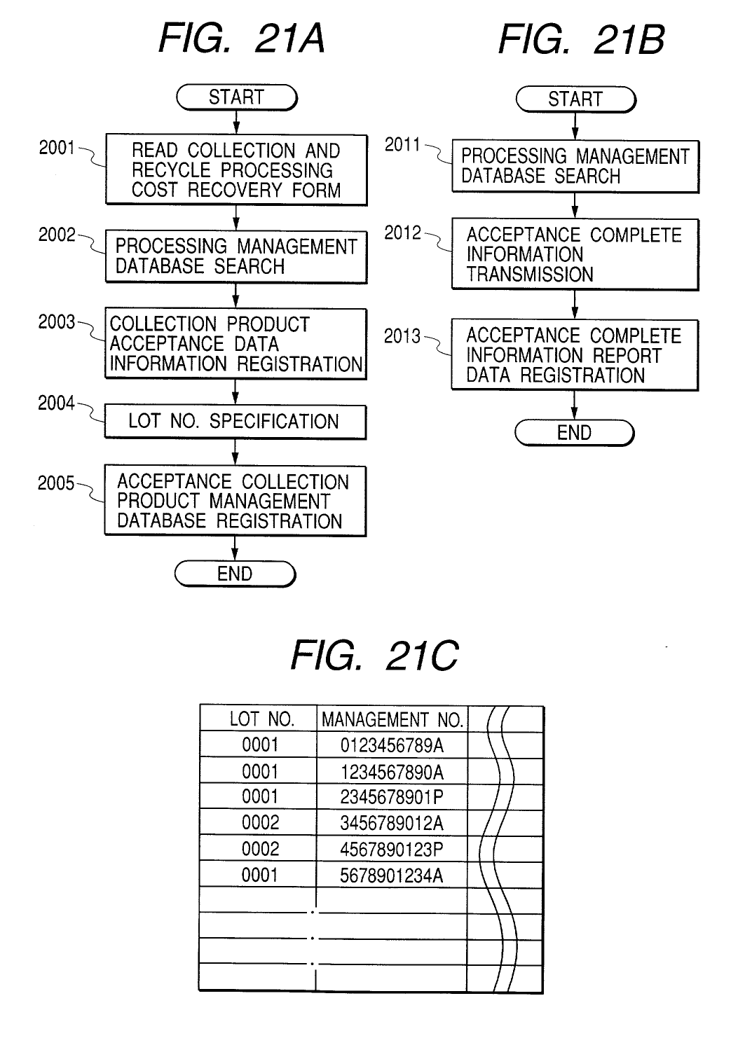

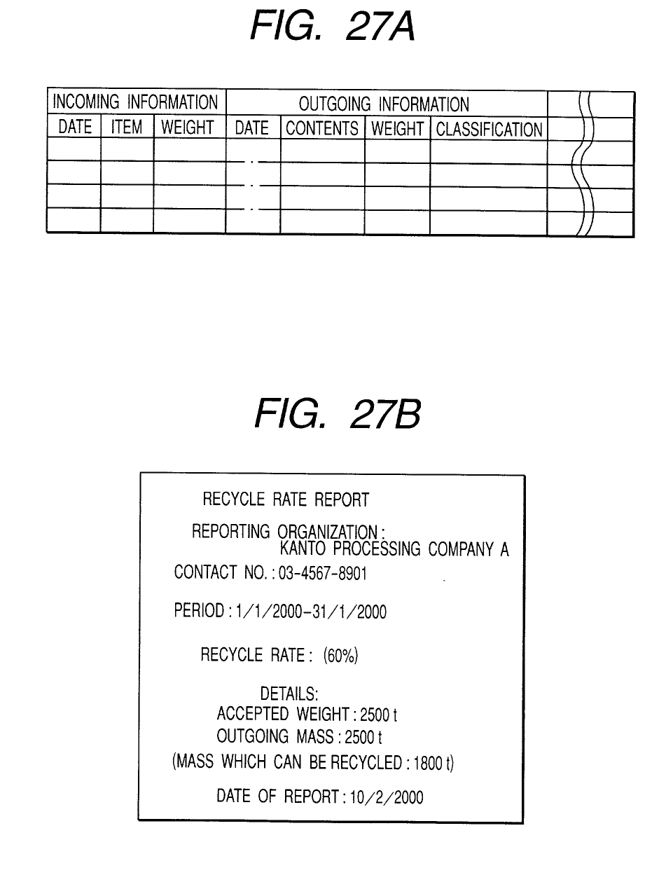

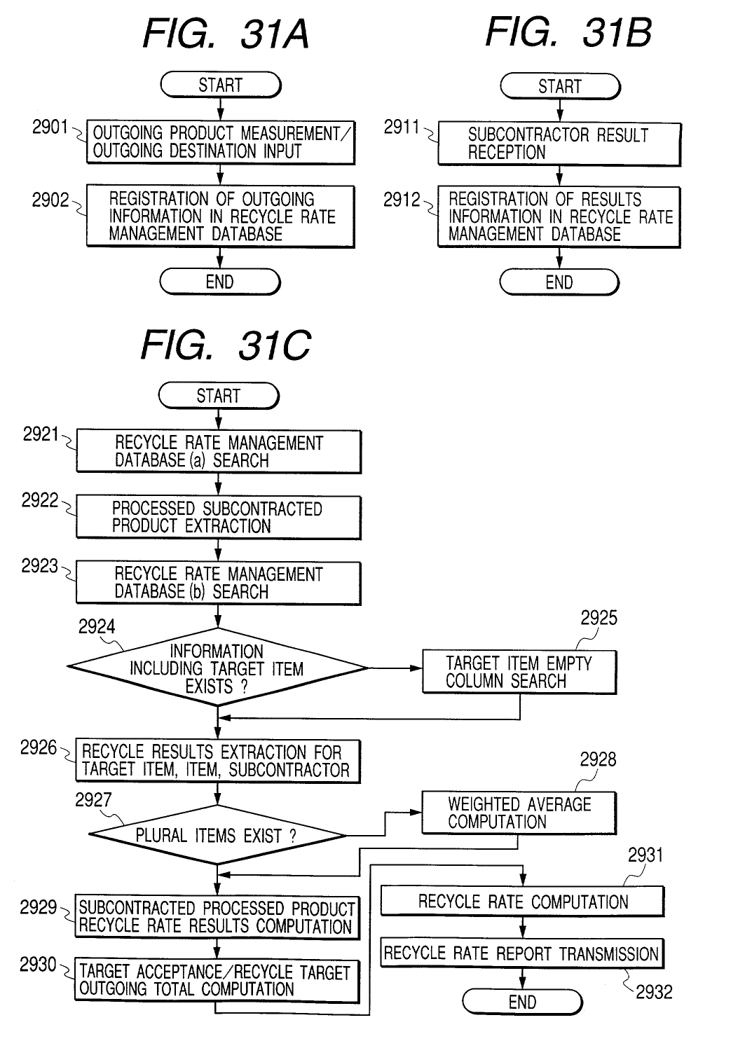

The detailed system construction of the parts collection center management system 15 is shown in FIG. 19. The storage device 24 manages the processing management database 248 whereof an example is shown in FIG. 20A, the re-use item providing management database 256 whereof an example is shown in FIG. 20B, the acceptance collection item management database 258 whereof an example is shown in FIG. 21C, the recycle rate management database 249 whereof an example shown in FIG. 27A, the product specification database 250 whereof an example is shown in FIG. 31, the product construction database 251, the parts specification database 252, the product parts needs database 253, and the re-use item providing management database 256.

The processing management database 248 manages the management numbers, collection item information, acceptance/disassembly information, and disassembly cost information. It is not absolutely necessary to provide all this information, although other information may also be provided. By managing lot numbers and management numbers, when management units are in lot number units in the parts collection center management system 15, the acceptance collection item management database 258 can link this information to the management number attached to each collection application. The recycle rate management database 249, product specification database 250, product composition database 251, parts specification database 252, product parts needs database 253, parts center management database 255 and re-use item provision management database 256 will be described in detail later.

FIG. 21A,B show the processing steps of the disassembly acceptance management system introduced into the processing device 22 of the parts collection center management system 15.

From the reception management center management system 11 and collection management center system 14, the communications device 21 first receives collection parts information such as the collection item management number, collection item type and quantity, and registers this in the processing management database 248. This communications means and database registration may be realized by identical means to those described earlier.

When the collection item is accepted, the management number which is on the collection item collection and recycle cost recovery management form is read by the reader 27 (step 2001). Next, the processing management database 248 is searched using this management number (step 2002), and the date of the acceptance date information for this collection item is registered (step 2003). The lot number (e.g., number on the case which stores this collection item) for managing this collection item is input (it is also possible to input the number on the case from a keyboard, or by marking a bar code on the case and reading it by a barcode reader) (step 2004), and this is registered in the acceptance collection item management database 258. In this way, the acceptance of collection items can easily be registered.

By the way, the flow do not have to carry out in this order. For example, when firstly the lot number specification is once carried out and all of the accepted collected products are registered as the lots, the lot number specification (corresponding to step 2004) may be carried out, and then steps 2001, 2002, 2004, and 2005 may be carried out for each of the lots. When the management is conducted not in lot units, the steps 2004 and 2005 are eliminated. When the collection application products are not previously acquired, the step 2003 is eliminated. After reading out the management number at the step 2001, information on the management number is newly generated to resister the reception date of the products. The collected products may be acquired by requesting the collected product information for the reception management center management system 11 by using the management number. This method is a general one.

The parts collection center management system 15 also searches the processing management database 248 at a predetermined interval such as one day, or at a preset interval or time according to the intention of the operator of the collection management center, or by a predetermined command from a keyboard or mouse, extracts information which has been accepted but which has not been reported (report date is not registered) (step 2011), transmits the acceptance date together with the management number as acceptance complete information regarding the corresponding collection item information (step 2012), and registers the date information as acceptance date report information (step 2013). In this way, the parts collection center management system 15 can register the acceptance complete information in the reception management center. Here, an identical information transmitting method can be used in the step 2012 as for the information shown in FIG. 18C.

Next, the method of the step 311 will be described in detail.

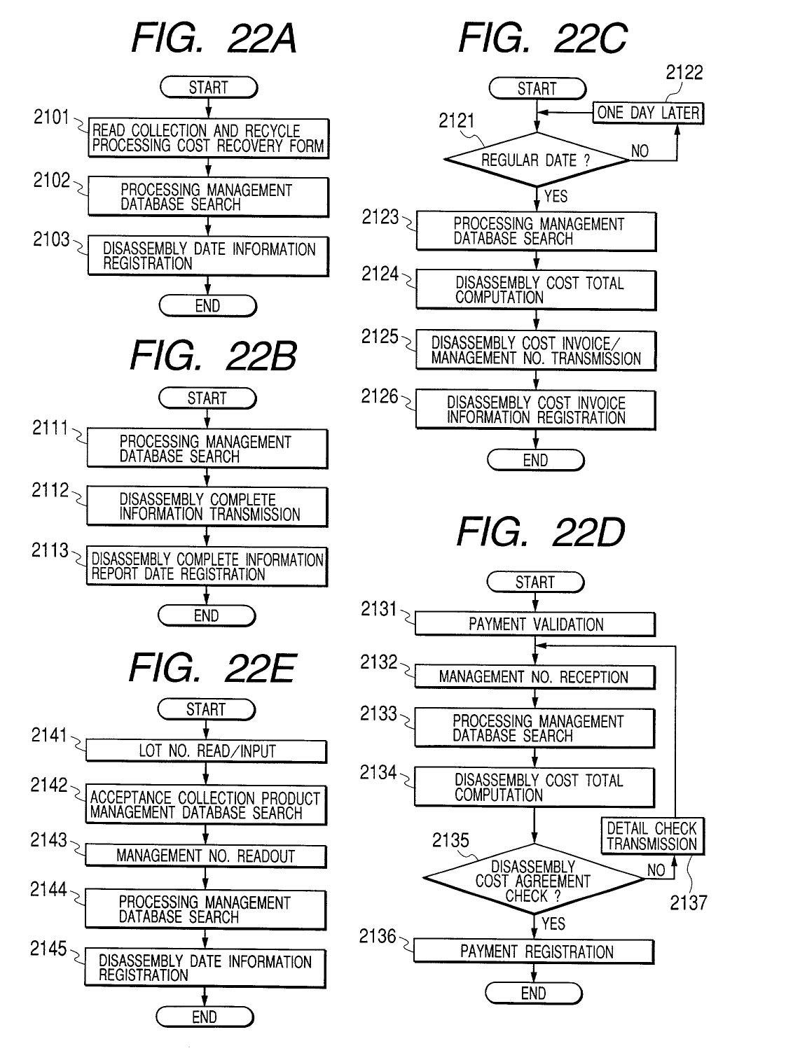

FIG. 22 shows the processing steps of the disassembly management system introduced in the processing device 22 of the parts collection center management system 15.

When disassembly has been performed after a collection item has been thrown onto the disassembly line, the management number on the collection and recycle cost recovery management form for the collection item is read by the reader 27 (step 2101). Next, the processing management database 248 is searched by the corresponding management number (step 2002), and the date of disassembly for this collection item is registered (step 2103). In this way, disassembly of the collection item can easily be registered.

When processing is performed during disassembly when a product is put on the disassembly line, when this is done in lot units, the lot number attached to a case or the like managed in lot units is input, or read (step 2141), the acceptance collection item management database 258 is searched based on this lot number (step 2142), the management number corresponding to this lot number is extracted (step 2143), the processing management database 248 is searched for all extracted management numbers (step 2144), and the disassembly date information for the collection item having this management number is registered (step 2145). In this way, disassembly of the collection item can be registered even more easily.

The parts collection center management system 15 also searches the processing management database 248 at a predetermined interval such as one day, or at a preset interval or time according to the intention of the operator of the collection management center, or by a predetermined command from a keyboard or mouse, extracts information for which disassembly has been performed but not reported (report date is not registered) (step 2111), transmits the disassembly date together with the management number regarding the corresponding collection item information (step 2112), and registers the date information as disassembly date report information (step 2113). In this way, the parts collection center management system 15 can register the disassembly complete information in the reception management center 11. Here, an identical information transmitting method can be used in the step 2112 as for the information shown in FIG. 18C.

The parts collection center management 15 searches collection items for which disassembly complete information is registered but disassembly cost has not been invoiced (this information is not registered) (step 2123) from the processing management database 248 at a fixed interval (e.g., every day, once every two days, once a week or once a month) (steps 2121, step 2122), computes the total amount of the disassembly cost for this product (step 2124), invoices the total amount of this disassembly cost by a predetermined method to the reception management center management system 11 together with the management number of the corresponding collection item (step 2125), and registers the invoicing date of the disassembly cost of the product (step 2126). In this way, the processing management center management system 15 can invoice the disassembly cost to the reception management center management system 11. Here, the transmission method in the step 2125 may be identical to the method shown in the step 1712.

Further, the parts collection center management system 15 confirms the payment amount (step 2131) and management number (step 2132) for the disassembly cost transferred together with the transmission of management number information from the reception management center management system 11, searches this management number from the processing management database 248 (step 2133), computes the total amount of the disassembly cost of the collection item (step 2134), and checks whether or not there is a match with the payment amount (step 2135). When it does match, payment information is registered for the disassembly cost of the product having this management number (step 2136). When it does not match in the step 2135, a confirmation message is transmitted by information such as the management number and payment amount to the reception management center management system 11 regarding the contents which do not match (step 2137), and payment management is performed for the disassembly cost by repeating until the payment amount matches the total amount.

In the step 2131, identical processing may be performed using transfer information from a financial institution which is the recipient of the payment information.

Next, management of collection, collection item acceptance and disassembly information in the reception management center management system 11 will be described referring to FIG. 23.

The collection management center 14 receives the management number of the collection item and information to the effect that collection is complete, which were transmitted in the step 1712 (step 2201). The reception management database 241 is searched from this management number (step 2202), and collection complete information is registered by registering the collection date of the collection item having this management number (step 2203). According to this method, the collection complete information of the collection item can easily be managed.

The parts collection center management system 15 receives the management number of the collection item and information to the effect that acceptance is complete which were transmitted and accepted in the step 2012 (step 2211). The reception management database 241 is searched from this management number (step 2212), and the collection item acceptance complete information is registered by registering the acceptance date of the collection item having this management number (step 2213). According to this method, the acceptance complete information for the collection item can easily be managed.

The parts collection center management system 15 also receives the management number of the collection item and information to the effect that disassembly is complete which were transmitted in the step 2112 (step 2221). The reception management database 241 is searched from this management number (step 2222), and collection item disassembly complete information is registered by registering the disassembly date of the collection item having this management number (step 2223). According to this method, the disassembly complete information of the collection item can easily be managed.

It is not absolutely necessary to manage all the information in the case of the collection time, parts collection center acceptance time and parts collection center disassembly time. Also, if a management category is provided in the reception management database 241 which is managed by the reception management center management system 11 even at other times, the management number of the collection item and information relating to its status is transmitted to the reception management center management system 11, and the system updates the reception management database 241 according to this information, the status may be managed more closely.

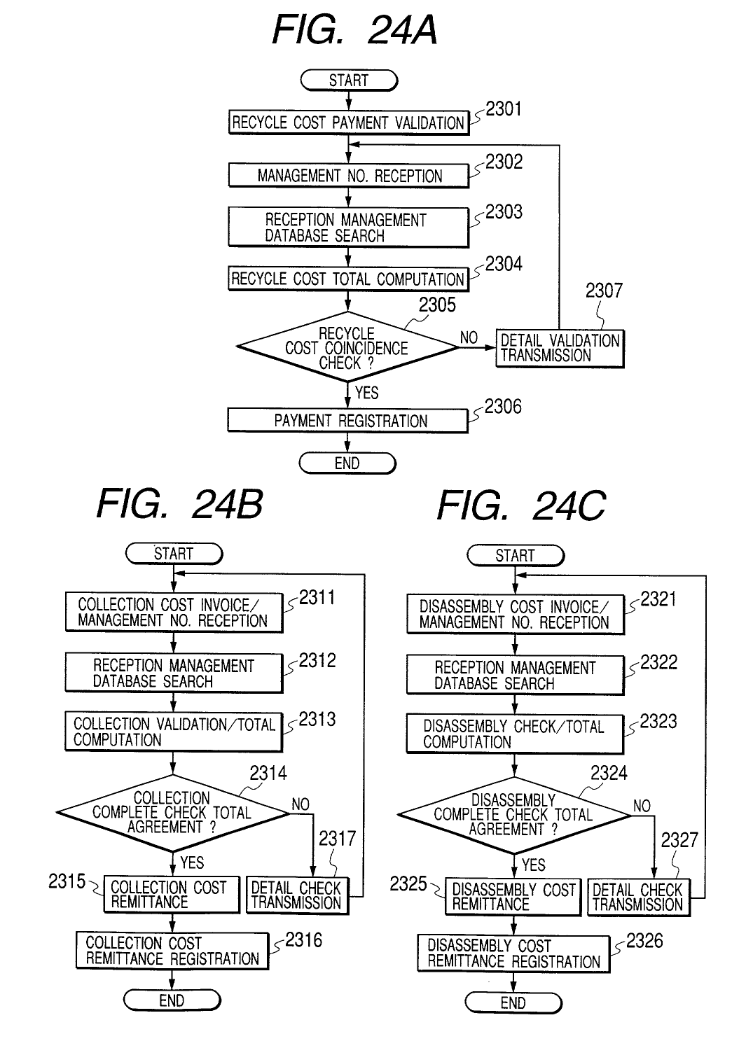

Next, the payment management of the recycle cost in the reception management center management system 11 will be described referring to FIG. 24A.

The recycle cost is paid while the collection company looks for a match with the management number in the step 1725 (step 2301, step 2302). Based on this information, the reception management database 241 is searched (step 2303), the total amount of the recycle cost for the corresponding reception number is computed (step 2304), and this is compared with the total amount paid in the step 2301 (step 2305). When there is agreement, the payment date of the recycle cost is registered for this management number, and the payment is registered (step 2306). When there is no agreement in the step 23 05, the management number and payment amount are checked (step 2307), and the agreement is checked. According to this method, payment of the recycle cost can be made without fail.

Next, payment management of the collection cost in the reception management center management system 11 will be described referring to FIG. 24B.

The collection management system 14 receives the invoice for the collection cost while looking for a match with the management number transmitted in the step 1735 (step 2311). The reception management database 241 is searched using this management number (step 2312), it is confirmed that collection of the collection item having this management number is complete (collection date information is registered), the collection cost relating to this collection item is extracted, and the total amount is computed (step 2313). Here, it is examined whether all collection items with invoiced management numbers have been collected, and whether the invoice amount in the step 2311 matches the total amount of the collection cost in the step 2313 (step 2314). When they match, the collection cost is transferred (step 2315), and the transferred date is registered in the reception management database 241 as collection cost transfer complete information (step 2316). In the step 2314, if any of the collection items were not collected, or if the total amount of the collection cost did not match, this is notified to the collection management system 14 (step 2317). According to this method, the payment of the collection cost is made when the collection of the collection item has definitely taken place, and payment of the recycle cost has also been made.

The remittance in the step 2315 may be performed by the ordinary procedure used by financial institutions. In this case, the name (number) of the recipient financial institution, account type, account number and account name of the collection company may be managed by the collection company database 242, and the corresponding information searched and extracted when the remittance is made.

Next, the payment management of the disassembly cost in the reception management center management system 11 will be described referring to FIG. 24C. The parts collection center management system 15 receives an invoice for the disassembly cost while looking for a match with the management number transmitted in the step 2135 (step 2321). The reception management database 241 is searched using this management number (step 2322), it is confirmed that the collection item having this management number has been disassembled (or disassembly acceptance is complete) (disassembly date or parts collection center acceptance date information is registered), the disassembly cost relating to this collection item is extracted, and the total amount is computed (step 2323). Here, it is confirmed for all collection items with invoiced management numbers that the recycle cost has been paid, disassembly is complete (or parts collection center acceptance is complete), and the invoice amount in the step 2321 matches the total amount of the disassembly cost in the step 2323 (step 2324). When there is a match, the disassembly cost is remitted (step 2325), and the remittance date is registered in the reception management database 241 as disassembly cost remittance complete information (step 2326). If the recycle cost of any of the collection items was not paid, disassembly is not complete (or parts collection center acceptance is not complete), or the total amount of the disassembly cost does not agree, this situation is notified to the parts collection center management database 15 (step 2327). According to this method, payment of the disassembly cost can be made after confirming that disassembly of the corresponding collection item (or parts collection center acceptance) has definitely taken place, and payment of the recycle cost has been made. The question of whether to take disassembly completion or parts collection center acceptance completion as a criterion for the determination depends on the difference in payment after disassembly has been made, or payment after responsibility has shifted due to parts collection center acceptance, but there is no difference as regards the system and the two cases can be dealt with in the same way.

The remittance in the step 2325 may also be performed by the ordinary procedure used by financial institutions. In this case, the name (number) of the recipient financial institution, account type, account number and account name of the collection company may be managed by the collection company database 242, and the corresponding information searched and extracted when the transfer is made.

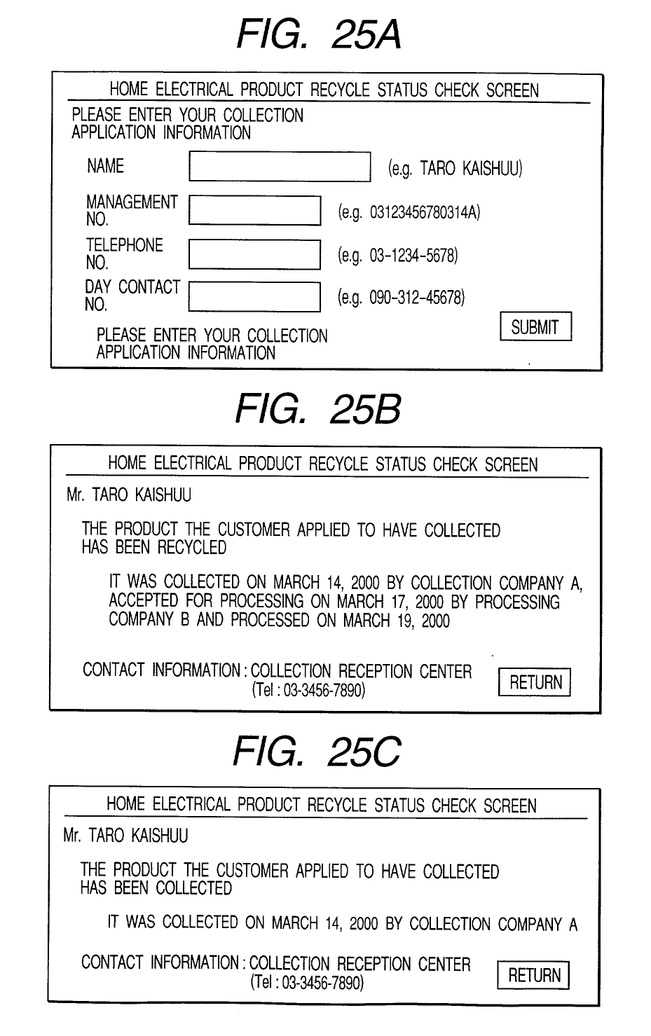

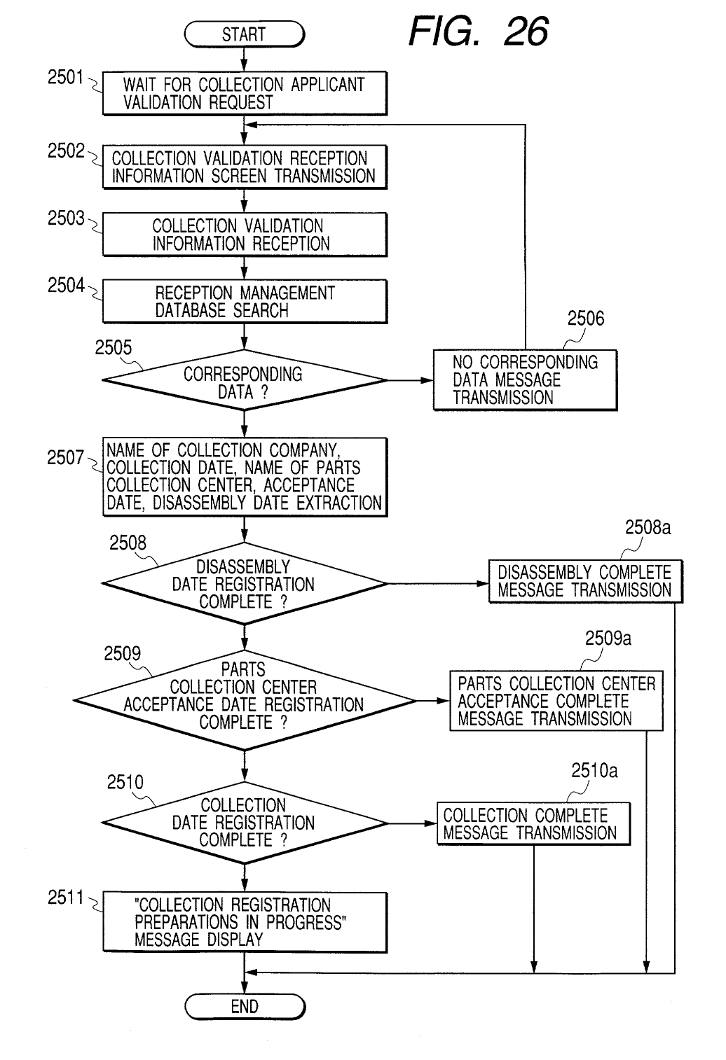

Next, the flow when the collection applicant checks the present situation of a collection application item will be described referring to FIG. 25.

When the collection applicant has performed a present status check via the network 28, the reception management center management system 11 transmits a collection recycle status check screen whereof an example is shown in FIG. 25A to the collection applicant (step 2501, 2502). This may be done by the method normally used on the Internet. The categories which suggest input here may be the management number or name and telephone number of the collection applicant which are set when the application is received, as shown by the example in FIG. 25A. It is not absolutely necessary to set or input all these categories, but it is preferable to use combinations of the management number and name, for example, in order to specify the collection applicant. Next, based on the information input and transmitted by the collection applicant (step 2503), the reception management database 241 is searched (step 2504). The search method may be an identical method to that of an ordinary database search. Here, collection application information is specified based on information such as the received management number and collection applicant name. When corresponding collection applicant information does not exist (step 2505), a message is transmitted to this effect (step 2506), and re-input of data is suggested (step 2502) or the routine may terminated without further modification. When corresponding collection application information does exist (step 2505), the company name, collection date, parts collection center name, acceptance date and disassembly date in the corresponding collection company information are extracted (step 2507), and it is determined, based on this information, whether disassembly registration is complete (step 2508), parts collection center acceptance registration is complete (step 2509), or collection registration is complete (step 2510). In the case of disassembly complete, an information screen showing recycle processing complete whereof an example shown in FIG. 25B may be transmitted (step 2508a). In the case of parts collection center acceptance complete, an information screen showing parts collection center acceptance complete may be transmitted (step 2509a, the screen is identical to FIG. 25B except that the display shows parts collection center acceptance complete). In the case of collection complete, an information screen showing collection complete whereof an example shown in FIG. 25C may be transmitted (step 2510a). If any of this information is not registered, a screen such as “collecting”, “preparing for collection” or “preparing for collection registration” may be output. If the contact information of the reception management center 2 is also displayed on the screen, a check can easily be performed if a data insufficiency occurs in the reception management center 2.

The above method assumes that verification by the collection applicant is made via the network 28, but if there are any queries by another means such as telephone or fax for example, the same processing can be performed if an operator who received this means performs an identical function to that of the aforesaid collection applicant using a nearby terminal, and the aforesaid contents displayed on the terminal are returned via telephone or fax.

It is also not absolutely necessary to make reports using the aforesaid demarcations, and more detailed information can be displayed such as “what delivery center is it at”, or “disassembly complete” when the parts collection center has received an item.

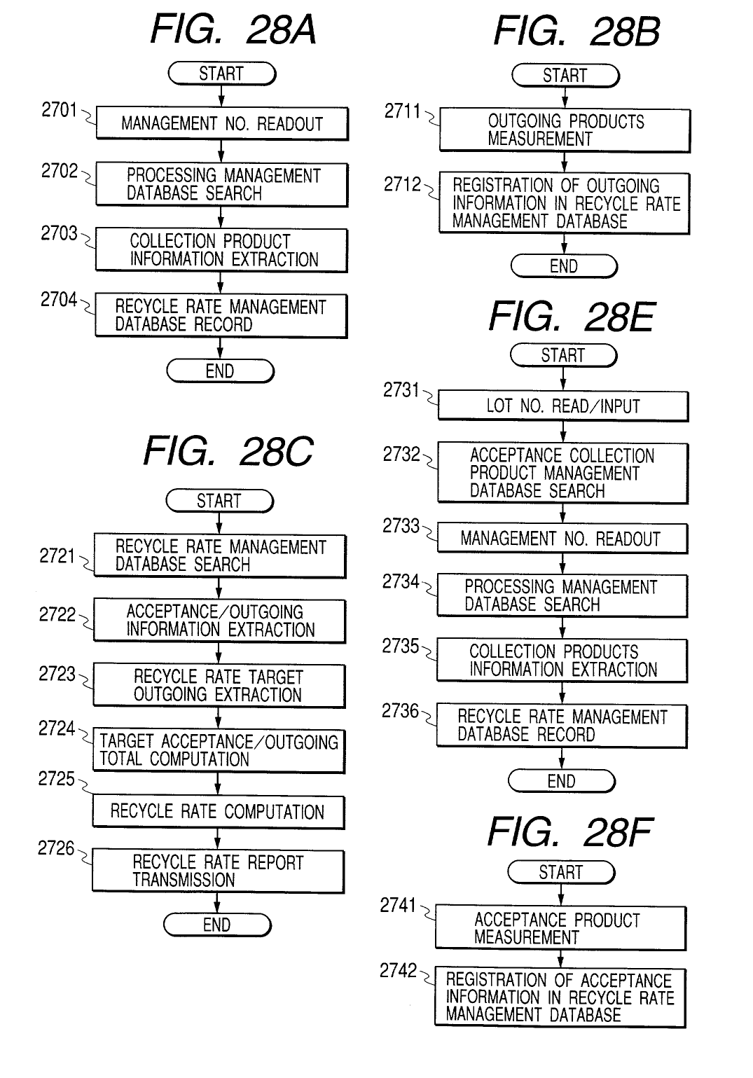

Next, the recycle rate management method in the parts collection center 5 will be described referring to FIG. 28. Here, the recycle rate is a proportion of outgoing items which were used effectively relative to incoming items under the management of the center, and this is generally managed on a weight basis. In the following embodiment also, management is basically performed on a weight basis. Effective use may refer to items used as materials, items taken in because of their value, items recovered by heat, and items used in some form other than reclamation, however there is no problem in the invention with any of these definitions, and the invention is not affected by this definition. The same is true for management methods (e.g. a parts number basis) other than a weight basis.

The system construction of the parts collection center management system 15 is shown in FIG. 19. Here, the recycle rate management database 249 manages incoming information such as incoming date, incoming weight, type and weight, and outgoing information such as outgoing date, outgoing content, outgoing weight and outgoing classification, as shown by the example in FIG. 27A. It is not absolutely necessary that the information comprises all this information, and other information may also be provided.

When a collection acceptance item is brought into a line such as disassembly, its management number is read (step 2701), the processing management database 248 is searched using this management number (step 2702), the type or weight of the collection item having this management number is extracted (step 2703), and this information is recorded in the incoming information of the recycle rate management database 249 (step 2704). Here, when the management of collection acceptance items is performed in lot units, the lot number (e.g., number of cargo lorry) is read (step 2731), the acceptance collection item management database 258 is searched based on this lot number (step 2732), the management number corresponding to this lot number is extracted (step 2733), the processing management database 248 is searched for all extracted management numbers (step 2734), the type or weight of the collection item having this management number is extracted (step 2735), and this information is recorded as incoming information of the recycle rate management database 249 (step 2736), hence incoming items can be more easily managed. Another method for managing the incoming weight is a method wherein, when for example a collection item is accepted, it is weighed using the weighing device 29 (step 2741) and registered in the recycle rate management database 2 4 9 together with the acceptance date (step 2742). Here, the weighing means is generally a method wherein the item is weighed on a platform together with a transport vehicle often seen in a large number of existing intermediate processing companies, and the cargo weight, i.e., the acceptance weight, is calculated using the difference from the weight result of the transport vehicle after unloading the cargo, however any measurement method for each item, product and cargo lorry may also be used. Further, if necessary, a classification made according to each type (personal computer/printer, desktop computer/notebook computer, by manufacturer or by product model) is required when later computing the recycle rate for each type, and if this is not required, it is not absolutely necessary. Hence, the incoming weight can be managed by this method.

Next, in the parts collection center 5, the item is weighed using the weighing device 29 for shipment as a re-use item, shipment as a material recycle item, or dispatch when the processing company 7 is entrusted with processing such as material recycling (step 2711), and the dispatch date, contents, type and dispatch weight are registered in the recycle rate management database 249 (step 2712). The weighing means is as described above. Information must be recorded for each processing item when the recycle rate has to be computed for each of these items. Dispatched items are separated according to each processing category, for example a hard disk recovered from a desktop computer and a hard disk recovered from a notebook computer, and may be weighed separately for each of them. If a method is adopted wherein materials are recovered by sorting after crushing, this can be done by a method which differentiates crushing and sorting of the lines, and which assigns a certain time for each product type input to the crushing machine. A method of weighing the crushed, sorted products is disclosed in detail in Japanese Patent Laid-Open No. Hei 10-277527.

The parts collection center management system 15 searches the recycle rate management database 249 at a predetermined interval such as for example once a month (step 2721), and extracts information in a period where the date of disassembly and date of dispatch in lot units is included in the total (step 2722). Here, of the dispatched items, only those included in the count of recycle rate are extracted (step 2723). This method may be a method wherein for example, during dispatch information registration (step 2712), information is input as to whether or not a dispatched item is a recycle item, and totals are calculated based on this flag. Alternatively, it may be a method wherein the dispatched item is read, a database of information specifying whether or not an item is a recycle item is separately available for each dispatch item, and it is determined whether or not recycling is possible for each item by comparing the two. This method may easily be realized by general information system technology, and the method itself is not specific. Next, the acceptance weight extracted in the step 2722 and the step 2723, and the possible recycle dispatch weight are summed (step 2724),

$$\begin{matrix}actual recycle rate \\ during this period\end{matrix} = \frac{\begin{matrix}\sum possible recycle dispatch \\ weight during the period\end{matrix} }{\begin{matrix}\sum acceptance mass \\ during the period\end{matrix}} \times 100 \% \qquad ( Eqn . 1 )$$

is applied to these, and the recycle rate during this period is computed (step 2725). This may be reported to the reception management center management system 11 (step 2726) in a predetermined format whereof an example is shown in FIG. 27B. The reporting means may be via the network 28, or by fax. Also, in FIG. 27B, it has been assumed that human operators will be in charge, but a method may also be envisaged wherein information is transmitted in a form easily processed by a computer whereof an example is shown in FIG. 14C.

When it is necessary to compute a recycle rate for each item, in the flow from the step 2722 to the step 2725, the extraction/summation/calculation in the acceptance information and dispatch information may be performed for each target item.

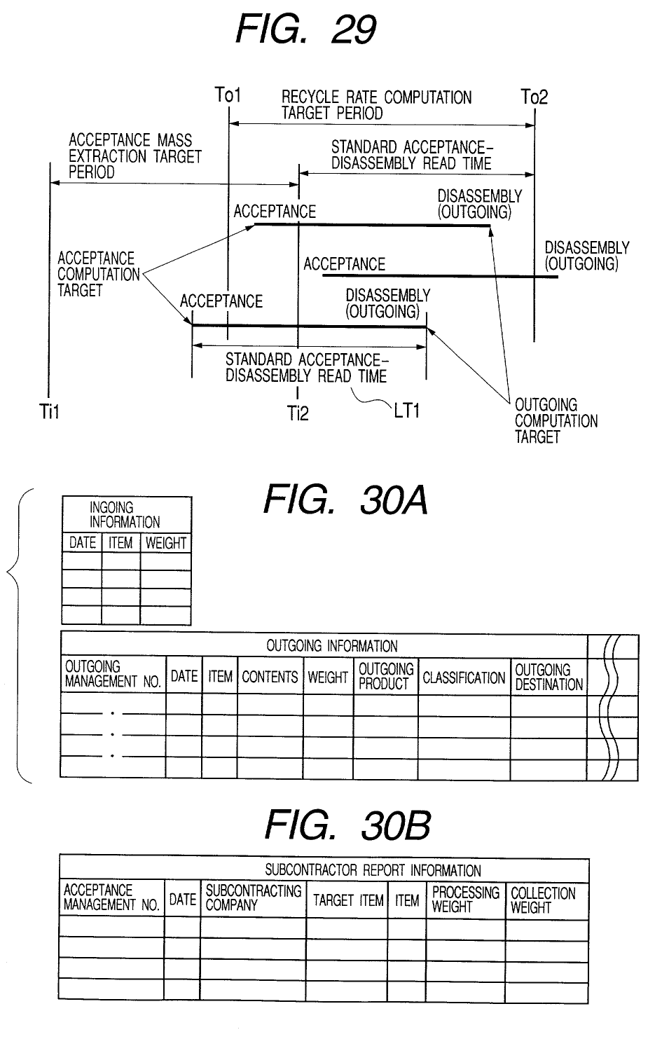

When there is a certain time from acceptance to disassembly and dispatch, the search/extraction period from the step 2721 to the step 2722 may be a different period for acceptance and dispatch taking account of the shift in the standard time. For example, as shown by the example of FIG. 29, when the recycle rate is computed in a certain period (To1 to To2 in the figure), regarding dispatch (numerator in Eqn. 1), information relating to dispatch in this period (To1 to To2 in the figure) from the step 2721 to the step 2723 is searched/extracted, but regarding acceptance (denominator in Eqn. 1), a lead time from standard acceptance to disassembly (dispatch) is taken into account, acceptance information in Li1 to Li2 (Li1+LT1−=Lo1, Li2+LT1=Lo2) in a period going back to this lead time is searched, and the calculation may be performed using these parameters. Here when there is a shift in the lead time due to the item, a more precise recycle rate modification can be performed by managing the lead time for each item, varying the aforesaid LT1 for each item and modifying the period for each item.

Next, the recycle rate management method comprising the operating results of the subcontractor processing company 7 in the parts collection center 5 will be described referring to FIG. 30, FIG. 31.

The system construction of the parts collection center management system 15 is as shown in FIG. 19. The recycle rate management database 249 in this case comprises a part where incoming information such as incoming date, incoming weight, item and weight, and acceptance dispatch information such as dispatch management number, dispatch date, dispatch item, dispatch contents, dispatch weight, dispatch products, dispatch classification and name of the subcontractor processing company are managed, whereof an example is shown in FIG. 30A, and a part relating to the subcontractor processing company which manages subcontractor processing result information such as acceptance management number (identical to the outgoing management number of the recycle rate management database (a)), processed product, report date, processed weight and collection result weight (referred to hereafter as recycle rate management database (b)), whereof an example is shown in FIG. 30B. It is not absolutely necessary that all the above information is present, but there may also be other information.

The management method for recycle items or items which have undergone disassembly until they are discarded in the yard of the parts collection center 5, is as described above. In addition, the recycle rate in the subcontractor processing company 7 is managed by the following method. Regarding externally consigned outgoing items, the mass is measured during consigned dispatches (step 2901), and after assigning a discharge management number, it is recorded in the recycle rate management database 249(a) together with the item and subcontractor processing company information (step 2902).

Regarding externally consigned products, the subcontractor (subcontracted) processing company 7 receives the name of the subcontractor processing company, subcontracted items, items, processing weight, collection (recycle) weight or recycle rate as the subcontracted product recycle result (step 2911), and this is recorded in the recycle rate management database 249(b) together with the date (step 2912). However, the subcontractor processing company is usually a company having special techniques for the items concerned. For example, a request to process HDD comes to a company having special techniques in the processing of HDD from several top disassembly companies. Here, if there is no advantage in separately processing HDD for desktop computers and notebook computers, they are often processed together. As a result, concerning this item (HDD in this example), the subcontractor processing company has difficulty in separating the items concerned (in this example, desktop and notebook computers). In this case, they may be separated from other items by leaving the column for the item blank. If the communications method between the subcontracting company and the subcontractor is a form which can easily be processed by a computer whereof an example is shown in FIG. 14C, automatic processing is easy. This method is a general one, and is not specific in any way. Regarding the recycle rate management method of the subcontractor processing company, the aforesaid method can be used.

In the disassembly collection center 5, at a predetermined interval such as for example once a month, the recycle rate management database 249(a) is searched (step 291), data which has been processed and subcontracted during this period (when subcontractor information exists) is extracted (step 2922), and the recycle rate management database 249(b) is searched using the subcontractor company, category and target category information in this data (step 2923). However, when there is no data for the target category in the recycle rate management database 249(b) (step 2924), the data is searched including those columns which are empty (step 2925). Also, when the recycle status report of the subcontractor processing company cannot be obtained in this period, an effort may be made to enlarge the search period in the step 2923 in order to use, for example, the results of last month. From the search, subcontractor processing results are extracted for each of the items concerned (sometimes, there may be none), items and subcontractor companies (step 2926). When there are plural results for this period (step 2927), the weighted average may be taken from:

$$\begin{matrix}actual recycle rate \\ during this period\end{matrix} = \frac{\begin{matrix}\sum actual recycle amount \\ during the period\end{matrix} }{\begin{matrix}\sum actual processed amount \\ during the period\end{matrix}} \times 100 \% \qquad ( Eqn . 2 )$$

(when the subcontractor processing company managed the results in terms of weights), or

$$\begin{matrix}actual recycle rate \\ during this period\end{matrix} = \frac{\begin{matrix}\sum actual processed amount \times \\ actual recycle rate\end{matrix} }{\begin{matrix}\sum Sigma actual \\ processed amount\end{matrix} } \times 100 \% \qquad ( Eqn . 3 )$$

(when the subcontractor processing company managed the results in terms of recycle rates)

(step 2928), or a method which uses the subcontractor processing result closest to the processing subcontracting date.

From the actual subcontracting amount relating to the subcontracted item extracted by identical means to that of step 2724, and the actual subcontracting result extracted in the step 2928,

$$\begin{matrix}actual recycle amount \\ during this period\end{matrix} = \begin{matrix}subcontracting amount total \\ mass during this period\end{matrix} \times \frac{recycle result of subcontractor}{processing result amount of consignee} \times 100 \qquad ( Eqn . 4 )$$

(when the subcontractor processing company managed the results in terms of weights), or

$$\begin{matrix}actual recycle rate \\ during this period\end{matrix} = \begin{matrix}subcontracted amount total \\ mass during this period\end{matrix} \times \begin{matrix}actual recycle rate \\ of subcontractor\end{matrix} \qquad ( Eqn . 5 )$$

when the subcontractor processing company managed the results in terms of recycle rates),

the actual recycle amount relating to the subcontracted processing product is calculated (step 2929). The operation may be performed in an identical way for all subcontracted processing products. This may be used as a total value for acceptance and dispatch using the dispatch amount which can be recycled in the step 2724 to calculate a total value for acceptance and dispatch (step 2930), the recycle rate result including the subcontractor result may be computed by Eqn. 1 (step 2931), and this may be reported to the reception management center management system 11 (step 2932) in a predetermined format whereof an example is shown in FIG. 28D. The reporting method is identical to that of the aforesaid step 2726.

In the subcontractor processing company, regarding subcontracted processing products, acceptance of the items concerned and recycle product dispatch management can be performed by managing according to the method described in FIG. 27, FIG. 28, FIG. 29, and the recycle result can be transmitted to the subcontracting company using this information (aforesaid step 2911).

In the subcontractor processing company, even when recycling is further entrusted to an outside processing company, by a repetition of the method described in FIG. 27, FIG. 28, FIG. 29 and FIG. 30, FIG. 31, in the upper processing subcontracting company, recycling results relating to a processing subcontracted product in a processing subcontractor position immediately below can be managed even when recycle processing has been commissioned two times or more, and by repeating this, the recycle results can be managed even by the uppermost parts collection center 5.

Another embodiment of the disassembly concerned with re-use of products and parts after the collection item has been delivered to the parts collection center, will now be described based on the drawings. According also to this embodiment, the overall construction of the system whereof an example is shown in FIG. 1, the functions whereof an example is shown in FIG. 2 and the hardware system construction whereof an example is shown in FIG. 3, are identical to the embodiment shown earlier.

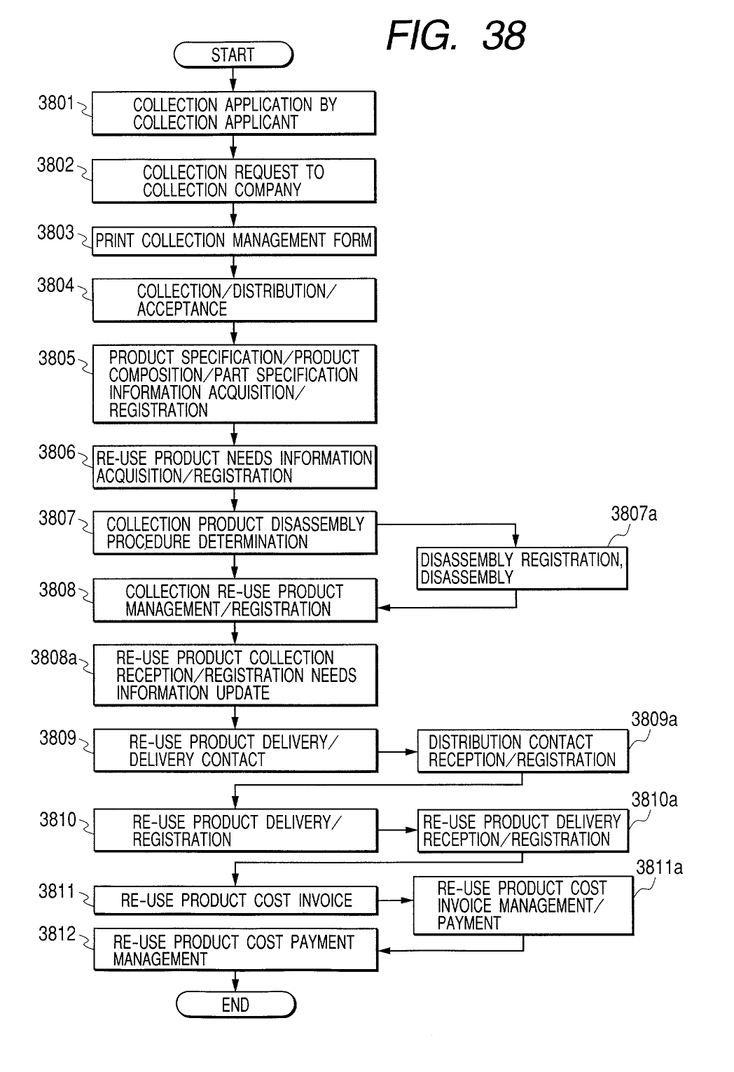

The flow of the invention will now be described referring to FIG. 38.

The flow from collection application by the collection applicant described using FIG. 4 (step 301), to collection and recycle cost recovery (step 308a) and reporting (step 309), is identical. In FIG. 38, this flow runs from a step 3801 to a step 3804. In the reception management center management system 11, the product specification from the manufacturer or its parts composition, and information relating to this parts specification, are first acquired, and accumulated in the storage device (step 3805). The reception management center also acquires needs information for re-used products and re-used parts from the parts center management system 18, and accumulates this (step 3806). The reception management center management system 11 manages this information in a form in which it can be provided to the parts collection center management system 15. In the parts collection center management system 15, information such as the product specification, product composition, parts usage, and needs for re-used products/parts is acquired by the reception management center management system 11, the disassembly method for this collection item is determined using information such as the collection item model in the acceptance information for the collection item (step 3807), and after disassembly registration of the collection item, disassembly is performed (step 3807a). Here, the collected re-use products/parts are assigned a re-use item management number and registered (step 3808), and in the reception management center management system 11, the re-use item collection registration and needs information is updated by transferring this information together with the name of the parts center to which delivery is to be made, re-use item model and price to the reception management center management system 11 (step 3808a). The parts collection center management system 15 delivers these re-use products/parts to the parts center 6 which desires these re-use items, and sends a delivery message (step 3809). In the parts center management system 18, the re-use item delivery message is received, and a current product acceptance check is performed (step 3809a). Also, regarding the delivered re-use items, the parts collection center management system 15 notifies the reception management center management system 11 as to the re-use item management number, delivery date and name of delivery parts center (step 3810). In the reception management center management system 11, based on this information, delivery registration of the re-use items is performed (step 3810a). Further, the reception management center management system 11 invoices the cost of the re-used items to the parts center 6 to which the re-use items were delivered (step 3811), the parts center management system 18 confirms whether acceptance of the re-use items is complete, and pays the fee (step 3811a). The reception management center's management system 11 confirms payment of the fee (step 3812).

These steps are not necessarily performed in this sequence, for example, the step 3805 or step 3806 can be performed first, and data then stored by the storage device in the parts collection center management system 15. Further, the same result can be achieved if the updating of the needs information in the step 3810a uses the information of the step 3807 or step 3807a, and the step 3808.

When products are re-used, it may occur that “disassembly operations” may not necessarily be performed on collection items, but in the context of this specification, electrical operations such as erasing the contents of a storage device or the case where only disassembly registration is performed, are represented as disassembly.

Here, the method of the step 3805 will be described in detail.

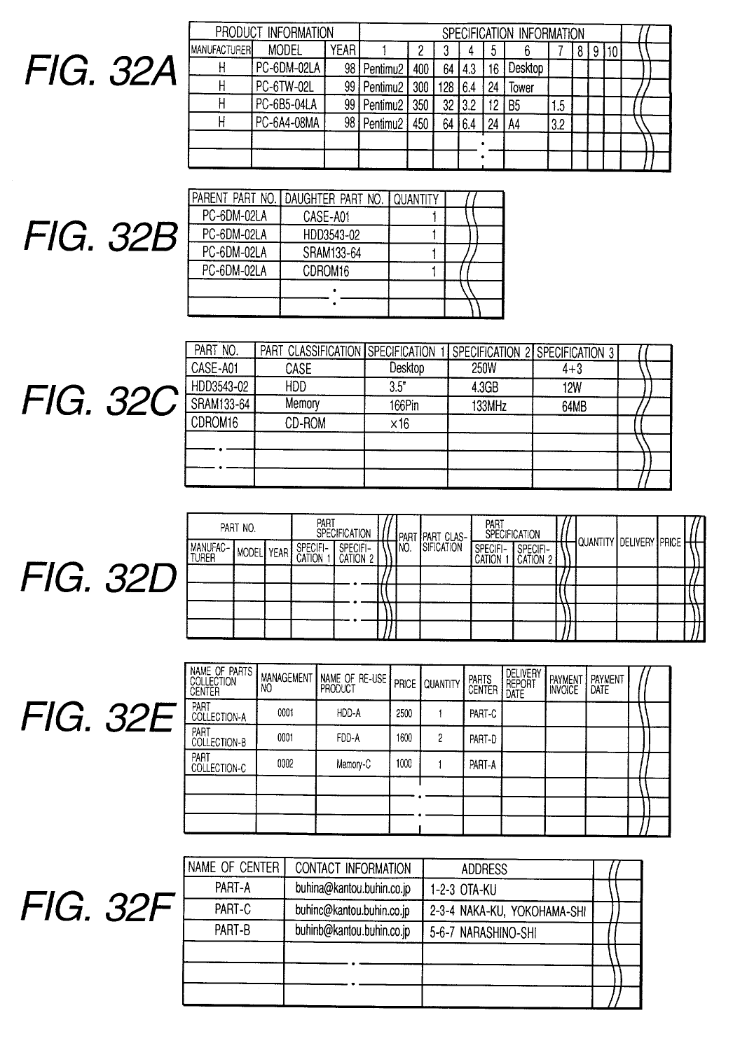

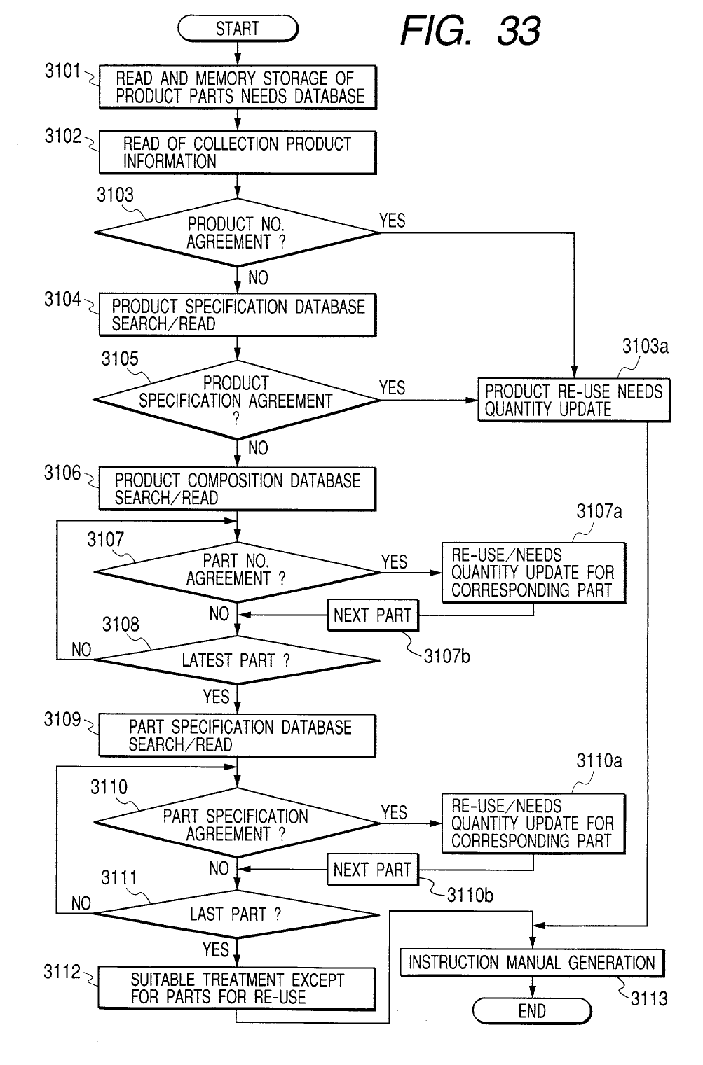

The detailed system construction of the reception management center management system 11 is shown in FIG. 9B. In addition to the reception management database 241, collection company database 242 and recycle cost database 243 which were already described in FIG. 9A, the storage device 24 manages a product specification database 250 whereof an example is shown in FIG. 32A, a product construction database 251 whereof an example is shown in FIG. 32B, a parts specification database 252 whereof an example is shown in FIG. 32C, a product parts needs database 253 whereof an example is shown in FIG. 32D, a re-use item management database 254 whereof an example is shown in FIG. 32E, and a parts center database 255 whereof an example is shown in FIG. 32F. Here, the product specification database 250 sets and manages product information such as manufacturer name, model, year and the main specification, as shown by the example in FIG. 32A, i.e., in the case of the example of FIG. 32A, for a personal computer, the first specification is the type of CPU, the second specification is the operating frequency of the CPU, the third specification is the memory capacity, the fourth specification is the capacity of the hard disk, the fifth specification is the speed of the CD-ROM, the sixth specification is the type of personal computer, and the second specification is the mass. The product composition database 251 manages information such as new parts, daughter parts and quantities by information which specifies parts such as the model, as shown by the example in FIG. 32B, and permits identification of the product composition. The parts specification database 252 manages information such as the model, parts type and specification, as shown by the example in FIG. 32C. Here, taking the parts of a personal computer as an example, in the case of a HDD (hard disk drive), the first specification is the size, the second specification is the capacity, and the third specification is the power consumption. There is no problem if these are different for each part type. The part model may also be managed as a parts number, or manufacturer parts number+parts manufacturer parts number, but from the viewpoint of the information system, these can be dealt with by identical processing. Also, in the example of FIG. 32C, the model was dealt with as one piece of information, but identical processing can be performed by the information system if this is managed as a combination of manufacturer parts model+parts manufacturer code or manufacturer parts model +parts manufacturer parts model. The product parts needs database 253 manages product information for products and parts which it is desired to re-use, such as manufacturer, model and year, and information such as product specification, parts model, parts type, parts specification, required quantity, invoice due date and desired price, as shown by the example of FIG. 32D. By providing this information, the required products and parts may be set not only from information such as the model, but also from the specification. The re-use item management database 254 manages re-use item management information such as the name of the parts collection center which is responsible, re-use item model, sales price, name of parts center to which the item is provided or sold, delivery report date, cost invoicing date and cost recovery date, and manages the provision of re-use items, and invoicing and recovery of charges, as shown in the example of FIG. 32E. The parts center database 255 manages the name of the parts center, its location and contact information, and invoices charges to the parts center providing re-use items as shown by the example of FIG. 32F. It is not absolutely necessary to provide all this information, and not all the information is required in the step 3805. There may also be other information in addition. Further, the parts center database 255 may also register information related to parts centers participating in this system as a database. This technique is the usual one.

From the product manufacturer and parts manufacturer, product specification information, product composition information and parts specification information such as the product or part model, year, specification and composition required for the product specification database 250 or product composition database 251 and parts specification database 252 are acquired by the network or a storage medium. This acquisition may be made with the timing of a fixed interval, or information may be transmitted by the manufacturer each time it is updated. According to this method, a file having the same data format as the above database, or a storage medium comprising this file, is transmitted and information is registered on a storage device from the file. Regarding information such as specifications of parts comprising the product, the product manufacturer may acquire this information from the parts manufacturer and register it together, or the parts manufacturer may directly provide information to the system, both of these methods being acceptable. Both of these methods are currently practiced and can be implemented.

The reception management center management system 11 adds this information for example to an area having a specific location code (e.g., an Internet URL), and by allowing for example users with a specific ID and password (e.g., the parts collection center management system 15) to view it, this information can be made available to the system.

Next, the method of the step 3806 will be described in detail.

The reception management center management system 11 acquires information such as product or parts models or specifications for which there is a need for re-use from the parts center management system 18. The parts center management system 18 transfers the needs information by for example sending a file which displays re-use product or parts needs information by a method such as, for example, the name of the parts center, needs product model, quantity and price, or the name of the parts center, needs parts specification, quantity and price, or a method such as the name of the parts center, needs product model and quantity increase or decrease (e.g., +3), to the reception management center management system 11. The reception management center management system 11 reads this file, searches the product parts needs database 253 using the name of the parts management center and needs product model information, etc., and if there is matching information, it updates this information by the data which was sent. Alternatively, if an increase or decrease value is transmitted whereof an example is shown later, the latest information is managed (stored by the storage device) by increasing or decreasing the previous quantity by the value which was sent. The reception management center management system 11 can perform the file transfer by disclosing a certain management location (e.g., Internet URL). A user managed by an ID and a password (the parts center management system 18) places the file by FTP (File Transfer Protocol) or the like, and the reception management center management system 11 then goes to read this file.

The reception management center management system 11 manages this information in an area which for example has a specific location code (e.g., Internet URL), and makes this information available to the system by allowing users who for example have a specific ID and password (e.g., the parts collection center management system 15) to view it.

Next, a method of supporting re-use products and parts from collection items in this system of the step 3807 will be described in detail referring to FIG. 32, FIG. 33. Hereafter, an example will be shown where a system comprising this method is introduced to the parts collection center management system 15, but an identical system may be introduced also, for example, to the reception management center management system 11, and commands issued to the parts collection center management system 15 using this result.

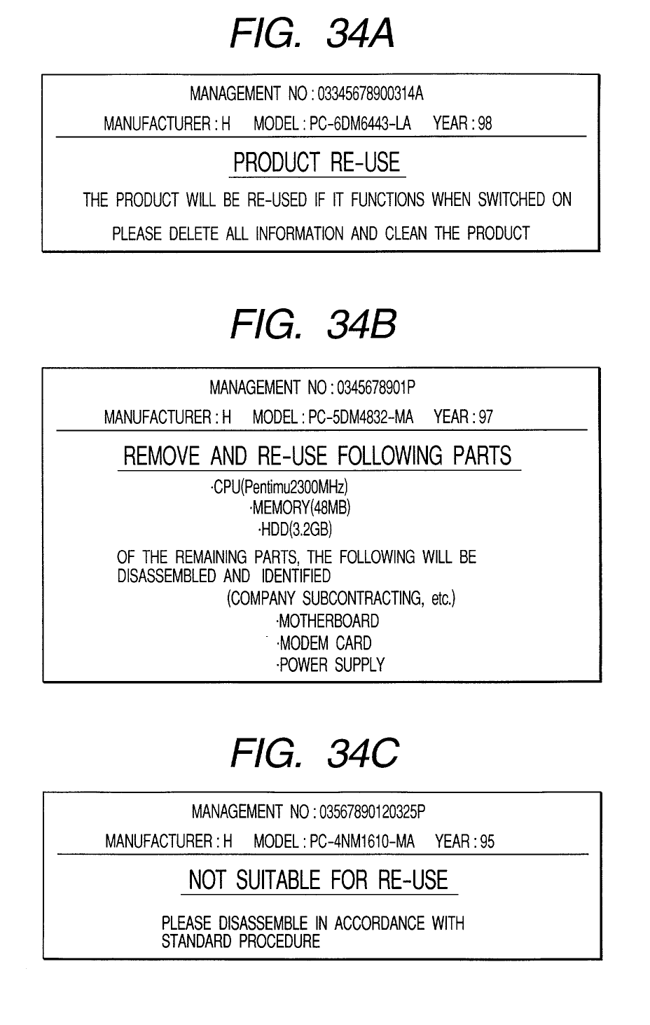

The system construction of the parts collection center management system 15 is shown in FIG. 19. Here, the product specification database 250, product composition database 251, parts specification database 252, product parts needs database 253 and parts center management database 255 are necessary for the acquisition and storage of the database information handled by the reception management center management system 11, and its construction is identical to the system databases whereof examples are shown respectively in FIG. 32A, B, C, D. The re-use item providing management database 256, as shown by the example of FIG. 20B, manages information such as the re-use item management number, re-use item model, quantity, sales price, invoice due date, name of parts center to which the item is sold, disassembly date, report date, delivery date and delivery report date. It is not absolutely necessary to provide all this information, although other information may be provided. When a collection item is disassembled, firstly, regarding products and parts, information about models and specifications for which there is a need is read from the product parts needs database 253, and stored in the memory (step 3101). Next, regarding the collection items concerned, this information is input by the input device 25 or read using the reader 27 (step 3102). In addition to reading or inputting the model directly, the management number of the collection management form attached to the collection item may for example be read, and information concerning management numbers and models accumulated in the processing management database 248 may also be examined. Here, the needs information stored in the read-only memory in the step 3101 and the model of the product acquired in the step 3102 are compared to see if they match (step 3103). If they match, and the needs quantity is one or more, the product is considered as a re-use product, and the needs quantity is updated (reduced by 1) (step 3103a). If they do not match, the routine proceeds to the next step. Next, the product specification database 250 is searched based on the product model, the product specification is extracted (step 3104), and this specification is compared with the product specification for which there is a need stored in memory in the step 3101 (step 3105). If they match, and the needs amount is one or more, the product is considered as a re-use product, and the needs quantity is updated (reduced by 1) (step 3103a). If they do not match, the routine proceeds to the next step. Here, where for example plural specifications are indicated, the question of how many of them must match to consider that there is agreement can be determined by assigning an order of priority to the specifications, or assigning symbols to required specification categories. Agreement of specifications may also be determined by providing criteria which include “perfect match”, “above specification” or “below specification” for each required specification. Next, if the provide specifications do not match, the product composition database 251 is searched by product, and parts included in the product are extracted (step 3106). Next, the part model for which there is a need stored in the memory in the step 3101 is compared with the part model read in the step 3106 (step 3107). If they match, and the needs quantity is one or more, the part is considered as a re-use part, and the needs quantity is updated (reduced by 1) (step 3107a). The routine then proceeds to the next part (step 3107b), and this is repeated until the last part (step 3107, 3107a, 3107b, 3108). Next, in the case of no match with the part model for which there was a need in the step 3107, the parts specification database 252 is searched, and the specification of the corresponding part is read (step 3109). This specification is compared with the parts specification stored in the memory in the step 3101 (step 3110). If they match, and the needs quantity is one or more parts, the part is considered as a re-use part, and the needs quantity is updated (reduced by 1)(step 3110a). This is repeated until the last part (step 3110, 3110a, 3110b, 3111). In the case of a part which was not a re-use part in the steps 3107a, 3110a, it is processed accordingly (considered for material recycling) (step 3112), and a working procedure whereof an example is shown in FIG. 34 is created (step 3113). FIG. 34A is an example where product re-use was assigned in the step 3103a, FIG. 34B is an example where a part for re-use was output in the steps 3107a, 3110a, and FIG. 34C is an example of a working procedure where there is no product or part re-use at step 3112, and only suitable processing was deemed necessary. In FIG. 34, the working procedure is shown as a document, but for example in a case such as FIG. 34B, instructions can be made easier to understand by displaying a cut-away diagram showing the positions of parts for removal.

According to this function, regarding collected products, products and parts for which there is a need can be efficiently selected which contributes to improvement of the re-use rate and recycle rate.

In the examples described so far, the sequence or display of the flowcharts does not necessarily have to follow this sequence or display, and the sequence or display has no effect on the invention provided that the same contents can be represented and displayed. Further, in the above examples, to use the network 28 and access the various databases, the Internet and ordinary database systems can be used.

Here, when disassembly of the collection items begins, disassembly is registered by registering the disassembly date in the processing management database 248 when the information for the collection items is read in the step 3102 (step 3807a).

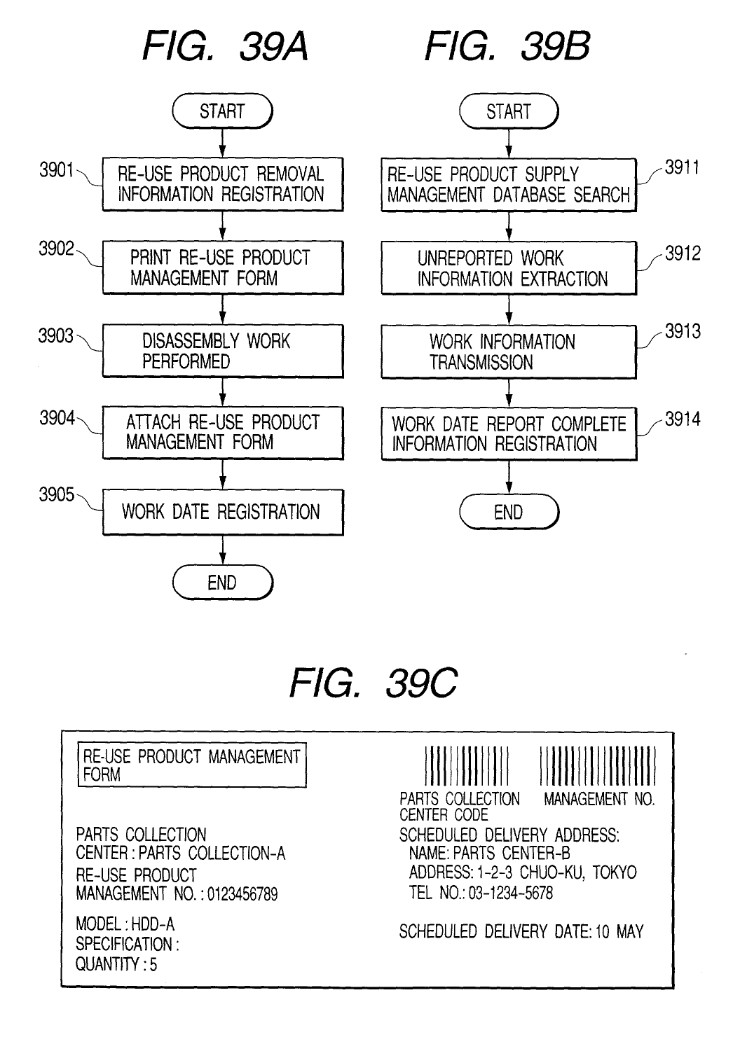

Here, the method of the step 3808 will be described in detail referring to FIG. 39.

Due to the procedure derived in the step 3807, products or parts which were disassembled and collected in the step 3807a for which there is a need for re-use, are registered in the re-use item providing management database 256. First, for re-use items collected in the step 3807, their model or specification, price, name of parts center to which they are sold and handling date are newly registered in the database 256 by re-use item providing management, and a re-use item management number is individually issued (step 3901). Here, when there are plural items having the same model or specification, subsequent management can be made easier by assigning a subsidiary number to the end of the re-use item management number. Simultaneously, a re-use item management form whereof an example is shown in FIG. 39C is printed so that the re-use item management number and name of the parts collection center which performed the work are visible (step 3902), and when the re-use item is disassembled (step 3903), the re-use item management form is attached to the corresponding re-use item (step 3904) and the collection date is registered (step 3905). It is also convenient if the name of the providing parts center is also printed on the re-use item management form.

Here, in the step 3901, when the disassembly procedure is determined in the step 3808, the re-use item management number is issued and registered in the re-use item providing management database 256, but all parts are not necessarily included in the collection items. For example, considering that some items may be damaged even if they are included, an arrangement may be made so that this information is registered subsequent to disassembly (step 3903), or easily deleted after disassembly.

The parts collection center management system 15, at a predetermined interval such as for example one day, or according to the intention of the system operator, searches the re-use item providing management database 256 at a preset interval or time, or upon a predetermined command from the keyboard or mouse (step 3911), extracts information for re-use items which are ready (handling date is registered) but which have not been reported (handling report date is not registered) (step 3912), and concerning this re-use item management information, it transmits re-use item collection report information such as the name of the parts collection center, re-use item management number, re-use item model or specification, quantity, price, re-use item collection date and scheduled parts center to which the items are to be provided, to the reception management center management system 11 (step 3913), and registers the handling report date (step 3914). Thus, the parts collection center management system 15 can register re-use item information for which work has been completed in the reception management center management system 11. Here, information can be transmitted in the step 3913 by sending a flag showing the parts collection center information, re-use item management number and operation complete information.

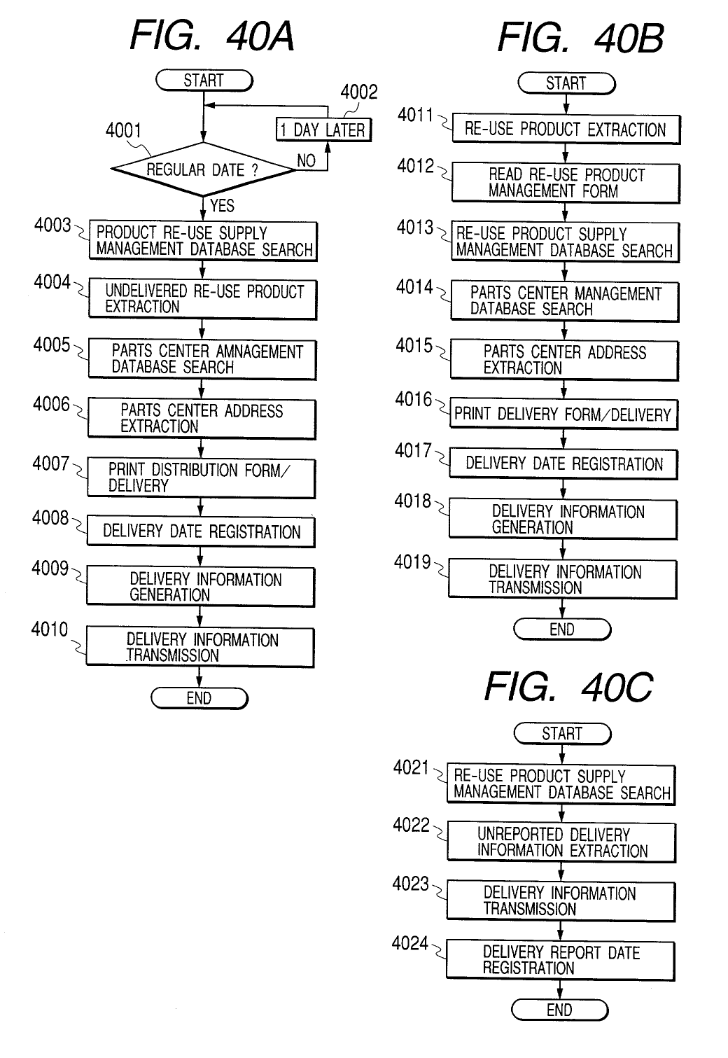

Next, the step 3809 will be described referring to FIG. 40.

The parts collection center management system 15, at a predetermined interval such as for example one day, or according to the intention of the system operator, searches the re-use item providing management database 256 (step 4003) at a preset interval or time (step 4001 to step 4002), or upon a predetermined command from the keyboard or mouse, extracts information for re-use items which are ready (handling date is registered) but which have not been delivered (delivery report date is not registered) (step 4004), and concerning this re-use item management information, searches the parts center management database 255 using the name of the parts center to which the items are to be sold (step 4005), extracts the location of the center (step 4006), prints the delivery form (ordinary delivery form or an ordinary parcel service delivery form in the case of small quantities) which directs the re-use item having the corresponding re-use item management number to the location of the corresponding parts center, delivers the re-use item using this delivery form (step 4007), and registers the delivery date of the corresponding re-use item (step 4008). Regarding this delivery, the same form may be used as the re-use item management form shown in FIG. 39C. Further, the delivery can be arranged by generating delivery information such as the name of the parts collection center, re-use item management number, delivered re-use part model or specification, quantity and delivery date (step 4009), and sending it to the parts center management system 18 via the network (step 4010).

In another delivery method, products which for example are considered as re-use items, managed or stored, and for which the due date is near (the due date may be displayed by for example simultaneously printing it when the re-use item management form is printed in the step 3902), the item is extracted from its storage location (step 4011), the re-use item management form for the re-use product is read (step 4012), the re-use item providing management database 256 is searched by the re-use item management number on the re-use item management form (step 4013), the parts center management database 255 is searched using the name of the parts center to which the item is to be sold in the extracted information (step 4014), the location of the center is extracted step 4015), the delivery form (ordinary delivery form or an ordinary parcel service delivery form in the case of small quantities) which directs the re-use item having the corresponding re-use item management number to the location of the corresponding parts center is printed, the re-use item is delivered using this delivery form (step 4016), and the delivery date of the corresponding re-use item is registered (step 4017). Regarding the delivery, the same form may be used as the re-use item management form shown in FIG. 39C. Further, the delivery can be arranged by generating delivery information such as the name of the parts collection center, re-use item management number, delivered re-use part model or specification, quantity and delivery date (step 4018), and sending it to the parts center management system 18 via the network (step 4019).

Here, in the step 4003 to the step 4004, and the step 4013 to the step 4014, the location information for the parts center to which the item is to be sold was searched and extracted, but this work may be performed before printing the re-use item management form of the step 3904, and the recipient printed beforehand on the re-use item management form, or alternatively, the re-use item management form and delivery form can be processed together. In this case also, there is no difference regarding the information categories which are managed, and this may be done by the same method.

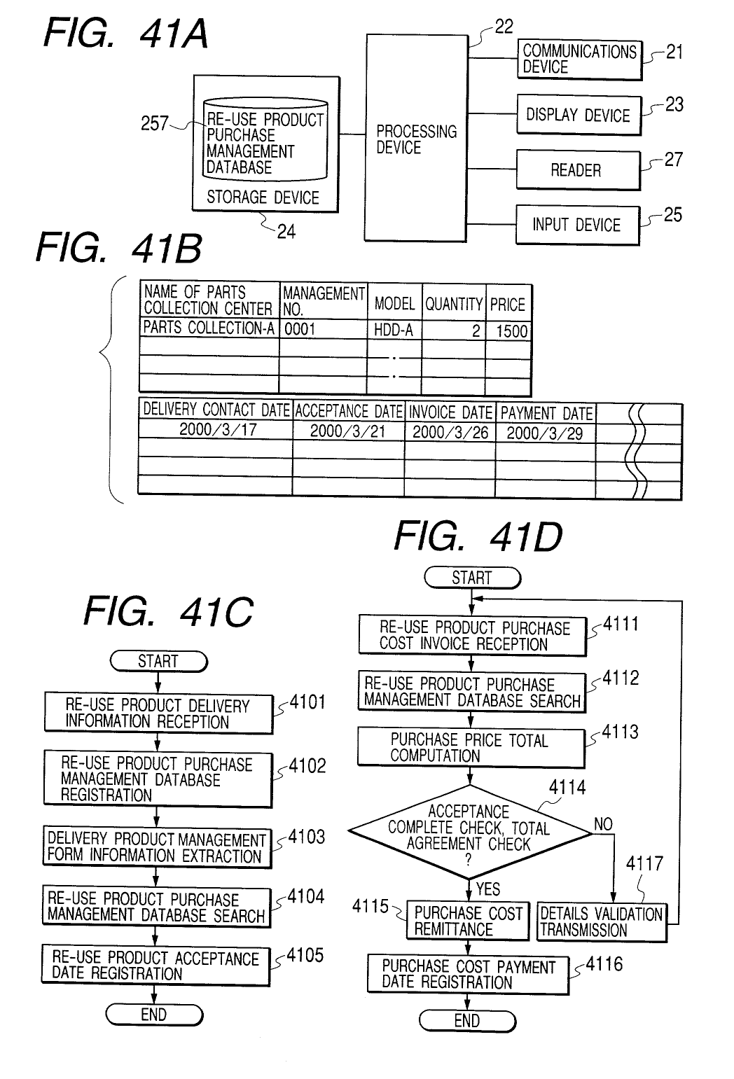

Next, the step 3809a will be described in detail referring to FIG. 41.

The detailed system construction of the parts center management system 18 is shown in FIG. 41A. The storage device 24 manages the re-use item purchase management database 257 whereof an example shown in FIG. 41B. The re-use item purchase management database 257 manages the information in the steps from purchase to invoicing and payment of re-use items such as the name of the parts collection center, re-use item management number, re-use item model, quantity, purchase price, delivery contact date, acceptance date, cost invoicing date and cost payment date. It is not absolutely necessary to provide all this information, for example some of it may be unnecessary if the quantity is managed in terms of one item at a time. The name of the parts collection center shows the parts collection center 5 which is responsible for work on these re-use items, but it is not necessary to specify it by name and the center may be specified by a management code instead. The database may contain other information. In the center, re-use item needs information is also managed and provided to the reception management center management system 11 (details in step 3806), but a database having the same contents as the reception management center management system 11 can also be registered although this will not be discussed in detail here.

As shown in FIG. 41C, the parts center management system 18 receives re-use item delivery information from the parts collection center management system 15 (transmitted in step 4010 or step 4019) (step 4101), and registers re-use item delivery information such as the name of the parts collection center, re-use item management number, delivered re-use item parts model or specification, quantity and delivery date in the re-use item purchase management database 257 (step 4102). When the re-use item delivered from the step 4007 or step 4016 is accepted by the parts collection center 5, acceptance of the delivered re-use item is managed by extracting information able to specify the delivered re-use item such as the name of the parts collection center and re-use item management number from the information on the delivery form, by reading the delivery form for the delivered item by the reader 27 or by input from the input device 25 (step 4103). The re-use item purchase management database 257 is then searched using this information (step 4104), and the acceptance date is registered for the corresponding information (step 4105).

Next, the step 3810 will be described in detail referring to FIG. 40.

The parts collection center management system 15, at a predetermined interval such as for example one day, or according to the intention of the system operator, searches the re-use item providing management database 256 at a preset interval or time, or upon a predetermined command from the keyboard or mouse (step 4021), extracts information for re-use items which have been delivered (delivery date is registered) but which have not been reported (delivery report date is not registered) (step 4022), and concerning this re-use item management information, transmits the delivery date together with the name of the parts collection center and re-use item management number (step 4023), and registers the delivery report date (step 4024). In this way, the parts collection center management system 15 can register the delivery complete re-use item information in the reception management center management system 11. Here, as the information transmitting method of the step 4023, re-use item delivery information such as the name of the parts collection center and re-use item management number, delivered item model or specification, quantity, providing price, name of the parts center to which the item is to be provided and delivery date may be transmitted as shown in FIG. 18C.

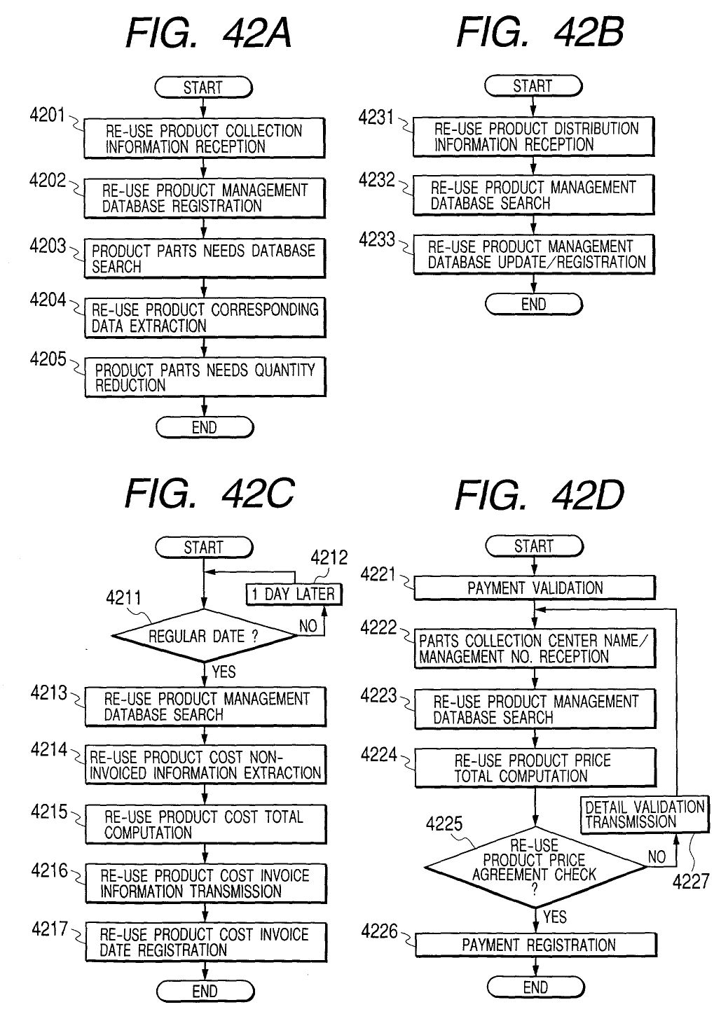

Next, the step 3808a, step 3810a, step 3811 and step 3812 will be described in detail referring to FIG. 42.

The reception management center management system 11 transmits re-use item collection report information such as the name of the parts collection center from which the item was sent by the parts collection center management system 15 in the step 3808, the re-use item management number, re-use item model or specification, quantity, price, re-use item collection date and scheduled parts center to which the item is to be provided (step 4201), and registers it in the re-use item management database 254 (step 4202). Here, a combination of the name of the parts collection center and re-use item management number may be used as a key to the database. It is not absolutely necessary that the parts collection center is specified by name, and for example a code assigned by the parts center may be used instead. Also, if a code which specifies the parts collection center is entered into the re-use item management number, (e.g., a number wherein the first five digits specifies the parts collection center), the name of the parts collection center itself is unnecessary. This can be done for the names of all centers and bases in the invention.

Further, the products/parts needs database 253 is searched using the re-use item model or specification and name of the scheduled parts center to which the items are to be provided from the received re-use item collection report information (step 4203), needs information matching this re-use item collection report information is extracted (step 4204) and the needs quantity of this information is reduced by the quantity of the re-use item collection report information (step 4205). In this way, regarding products/parts needs, the needs information is reduced for items which have been extracted from collection items, and more precise needs information can be transmitted to the parts collection center management system 15.

In this example, the re-use item collection report information from the parts collection center management system 15 is registered in the re-use item management database 254 and the needs information in the products/parts needs database 253 is updated, but the needs information can also be similarly updated by transmitting this information to the reception management center management system 11 when, for example, the disassembly schedule for the collection item is determined in the step 3807 or when the re-use item delivery report is made in the step 3810. However, if they were not many corresponding parts in the collection item or an even larger number was contained therein when the disassembly schedule for the collection item was determined in the step 3807, it is difficult to precisely grasp the re-use item collection quantity. Also, when the delivery report is made in the step 3810, it takes some time from when the re-use item is actually collected to when it is delivered, and the updating of the needs information may be delayed. Therefore, the updating of the needs information should be performed as soon as possible after extracting the re-use item from the collection items (step 3808a in FIG. 38).

The reception management center management system 11 then receives the re-use item delivery information such as the name of the parts collection center, re-use item management number and delivery date which were sent by the parts collection center management system 15 in the step 3810 (step 4231), searches the re-use item management database 254 using the parts collection center name and re-use item management number (step 4232), updates the name of the parts center to which delivery is made (even if only different from the registration complete information) and registers the delivery date for the corresponding re-use item information (step 4233).

In this way, based on the information from the parts election center management system 15, the delivery of the re-use item to the parts center can be managed by the reception management center management system 11.

The reception management center management system 11 searches the re-use item management database 254 at a fixed interval (e.g., every day, once in two days, once a week or once a month) (step 4211, 4212) (step 4213), extracts re-use items for which delivery date information has been registered but for which the re-use item cost has not been invoiced (this information is not registered) (step 4214), and extracts the sum total of the sales price of the corresponding re-use item (step 4215). The sum total is transmitted by the predetermined method to the parts center management system 11 to which the item is to be delivered together with the name of the parts collection center responsible for the re-use item and the re-use item management number, the sale of the corresponding re-use item is invoiced (step 4216), and the sales price invoice date for the corresponding re-use item is registered (step 4217). In this way, the reception management center management system 11 can invoice the parts center management system 18 for the sale of the re-use item. Here, the transmission method in the step 4216 may be identical to that shown in the step 1712.

Further, regarding the re-use item purchase cost transferred together with the transmission of the name of the parts collection center and the re-use item management number from the parts center management system 18, the reception management center management system 11 verifies the payment sum (step 4221) and the name of the parts collection center and re-use item management number (step 4222), searches the name of the corresponding parts collection center and re-use item management number from the re-use item management database 254 (step 4223), computes the sum total of the sales price of the corresponding re-use item (step 4224), verifies whether the payment sum matches (step 4225), and if it does match, registers payment complete information (step 4226) for the name of the corresponding parts collection center and the sales price of the re-use item having the re-use item management number. When it does not match in the step 4225, a confirmation message is sent regarding the details which do not match, such as the name of the corresponding parts collection center, re-use item management number and payment sum, to the parts collection center management system 18 (step 4227), and payment management of the sales price of the re-use item is performed by repeating until the payment sum matches the total sum. In the step 4221, identical processing can be performed using paying information from a financial institution as the acquirer of the payment information.

Next, the payment management of the purchased re-use item cost in the parts center management system 18 of the step 3811a will be described in detail referring to FIG. 41D.

The reception management center management system 11 sends an invoice for the purchased re-use item cost while verifying agreement between the name of the parts collection center and re-use item management number sent in the step 4216 (step 4111). The re-use item purchase management database 257 is searched using the name of the parts collection center and re-use item management number (step 4112), it is verified that reception of the name of the corresponding parts collection center and re-use item having the re-use item management number is complete (reception date information is registered), the purchase price of the re-use item is extracted, and this sum total is computed (step 4113). Here, for the names of all parts collection centers and collection items having re-use management numbers which were invoiced, it is examined whether acceptance is complete, and whether the invoice amount in the step 4111 matches the sum total of the purchase price of the re-use item in the step 4113 (step 4114). When they match, the purchase cost of the re-use item is transferred (step 4115), and the transfer date is registered in the re-use item purchase management database 257 as re-use item purchase cost transfer complete information (step 4116). In the step 414, if any of the re-use items have not been accepted, or the sum total of the re-use item purchase price does not match, this is notified to the reception management center management system 11 (step 4117). According to this method, payment of the purchase cost of the re-use item can be performed after verifying that the corresponding re-use item was definitely accepted. Transfer in the step 4115 may be performed by the normal procedure using a financial institution.

According to the invention, when home products are collected and recycled, the collection applicant can easily make a collection application, make an estimate of the cost required for recycling at that time, can verify reception of the collection application, and can easily comprehend the collection/processing status of the collection item after it is collected. The collection company can acquire collection request information wherein the collection schedule has been arranged, can easily generate a collection form based on this information, and can easily manage collection by a management number attached to the collection form. The parts collection center can easily manage acceptance and disassembly of collection items using the management number attached to the collection form, and by acquiring information relating to the collection item which is scheduled to be accepted, can propose a disassembly plan which contributes to enhancing the recycling of products and parts. The manufacturer, by acquiring information relating to recycle rate, can plan manufacture and maintenance based on recirculation of goods which assumes the re-use of products and parts, and the status of each collection application item can easily be verified and reported to the customer. Further, as the situation of collection items is managed electronically, a large reduction of management costs is possible which has a major impact on the collection and recycling of individual home products.

What is claimed is:

1. A recycle management method wherein a management number is issued from collection application information received from a collection applicant system, collection request information is generated based on said management number, and collection management, delivery management, disassembly management and cost management of collected products are performed using a network by transmitting said collection request information to the management system of a predetermined collection company.

2. A collection/recycle reception management method for products using a storage device which manages collection application/management information comprising the name, contact information and collection address of a collection applicant, collection application product classification, collection application product quantity, recycle cost payment method, scheduled collection company name and recycle cost estimate, a storage device which manages collection company information comprising the name, contact information and area of operation of each collection company undertaking collection work, and a storage device which manages recycle cost information comprising product classification and product model number, collection cost and disassembly cost for each group of products, wherein:
collection application screen information is sent to said collection applicant system by collection request information received from a terminal in the collection applicant system;
collection application information comprising the name, contact information and collection address of the collection applicant, collection application product classification, collection application product quantity and recycle cost payment method returned by the collection applicant is received, and stored together with a management number including said collection application information;
said collection company information is searched from said collection application information, the collection company responsible for collection is extracted, said recycle cost information is searched, a recycle cost estimate for the corresponding collection application product is extracted and said extracted collection company information and recycle cost estimate are stored in said storage device;
information relating to said extracted collection company information and recycle cost estimate is returned to said collection applicant system together with the relevant management number; and
the collection application for the collection application product is received and managed.

3. A collection/recycle collection request method for products using a storage device which manages collection application/management information comprising a management number, name, contact information and collection address of a collection applicant, collection application product classification, collection application product quantity, recycle cost estimate, recycle cost recovery method, scheduled collection company name and collection request date, and a storage device which manages collection company information comprising the name and contact information of the collection company, wherein:
uncollected items are extracted from the collection/management information from a storage status such as absence of collection request date information;
collection company information for the corresponding items is searched using scheduled collection company names in the collection application/management information; and
a collection request is deemed to be complete when collection request information comprising the management number of the corresponding information, name, contact information and collection address of the collection applicant, collection application product classification, collection application product quantity, recycle cost estimate and recycle cost recovery method are transmitted to the contact address of the collection company via a network, and the transmission date of the corresponding collection request information is registered in said storage device.

4. The collection/recycle reception management method for products as defined in claim 3, using a storage device which manages the management number, name, contact information and collection address of a collection applicant, collection application product classification, collection application product quantity, recycle cost estimate, recycle cost recovery method, collection application/management information for a collection request date, and collection company information comprising the name and contact information of a collection company or recycle cost management information comprising the management number, recycle cost estimate, recycle cost recovery method and recycle cost recovery date, and communication means which acquires payment information comprising payer specific information such as a management number, payment date and payment amount from a financial institution system, wherein:
recycle cost management information is searched using payer specific information such as the management number, payer's name and payer's telephone number contained in payment information from the financial institution system, the management number corresponding to this payment is specified, and a recycle cost recovery date or recycle cost payment contact date relating to the recycle cost management information for the corresponding management number, is registered;
the recycle cost is recovered and a collection request is extracted from application information for uncollected products, due to a storage situation wherein the recycle cost recovery date or recycle cost payment contact date is registered in recycle cost management information, but collection request date information is not recorded in the collection application/management information; and
collection company information is searched for the corresponding information using scheduled collection company names in the collection application/management information, and a collection request is deemed to be complete when collection request information comprising the management number of the corresponding information, name, contact information and collection address of the collection applicant, collection application product classification, collection application product quantity, recycle cost estimate and recycle cost recovery method are transmitted to the contact address of the collection company via communication means, and the transmission date of the corresponding collection request information is registered in said storage device.

5. A collection item status management method using a storage device which manages collection item status management information such as management number, collection application date, collection date, collection center reception date and collection center disassembly date, an input device such as a barcode reader, keyboard or mouse which updates information using collection item status information comprising categories for which a management number can be specified and status report information such as a collection complete report specifying collection complete, delivery to collection center complete, acceptance by collection center complete and collection center disassembly complete, a report of delivery to the collection center, a report of acceptance by the collection center and a report of collection center disassembly complete, or communication means which inputs these automatically, wherein:
the management number which specifies the corresponding application is registered at the time of the collection application;
at all or some of the times when status management of collection/recycling may be necessary for delivery to the collection center, acceptance by the collection center and disassembly including re-use of products and, collection item status report information, for example collection complete reports such as collection complete, collection company pickup complete, collection center delivery complete, collection center acceptance complete and collection center disassembly complete, and collection company pickup reports, collection center delivery reports, collection center acceptance reports and collection center disassembly complete reports are accepted via a network; and
said storage device is searched using the specific categories for information having a management number, and for this information, the status of the collection items is managed by updating the collection item status.

6. A collection application item collection status report method for collection/recycling of products using a storage device which manages collection item status management information such as management number, collection application date, collection date, collection company pickup date, collection center delivery date, collection center acceptance date and collection center disassembly date, wherein:
a collection application item status report reception screen is transmitted to the collection applicant system by collection request information from the collection applicant;
the storage device is searched using categories specifying the collection application information such as the management number input on this screen, and status regarding this information is extracted; and
the status of the collection item can be reported to the collection applicant by transmitting the extracted collection applicant item status to the collection applicant system.

7. A collection item collection delivery management method for collection/recycling of products using a storage device which stores all or part of collection delivery information comprising the management number, name of the collection applicant, contact details, address of collection scheduled collection date, collection date, collection report date, collection company pickup date, and collection pickup report date, collection center delivery date, collection center delivery report date and name of collection center to which delivery is made, wherein:
one or more pieces of information comprising information wherein the collection date is registered but the collection report date is not yet registered, information wherein the collection company pickup date is registered but the collection company pickup report date is not yet registered, and information wherein the collection center delivery date is registered but the collection center delivery report date is not yet registered, is extracted by searching this collection delivery information;
all or part of the collection report information such as the management number, collection company name and collection date, collection company pickup complete report information comprising the management number, collection company name and collection company pickup date, and collection center delivery complete report information comprising the management number, delivery company name, collection center delivery date and name of collection center to which delivery is made, is generated using this collection delivery information, taking the above information as collection complete unreported information, collection company pickup unreported information and collection center delivery unreported information; and
one or more of these pieces of information is transmitted to a reception management center via a network, and completion of collection and delivery for these management numbers is registered by registering the collection report date of the collection delivery information, collection company pickup report date and collection center delivery report date.

8. The collection item collection delivery management method for collection/recycling of products as defined in claim 7, using a storage device which stores all or part of collection delivery information comprising the management number, name of the collection applicant, contact details, collection address, scheduled collection date, collection date, collection report date, collection company pickup date, collection pickup report date, collection center delivery date, collection center delivery report date and name of collection center to which delivery is made, and collection application item information such as collection application item type, collection application item quantity and collection application item model, wherein:
one or more pieces of information comprising information wherein the collection date is registered but the collection report date is not yet registered, information wherein the collection company pickup date is registered but the collection company pickup report date is not yet registered, and information wherein the collection center delivery date is registered but the collection center delivery report date is not yet registered, is extracted by searching this collection delivery information;
all or part of the collection report information together with collection application item information to which additions are made at this base such as the management number, collection company name and collection date, collection company pickup complete report information together with collection application item information to which additions are made at this base such as the management number, collection company name and collection company pickup date, and collection center delivery complete report information together with collection application item information to which additions are made at this base such as the management number, delivery company name, collection center delivery date and name of the collection center to which delivery is made, is generated using this collection delivery information and collection application item information, taking the above information as collection complete unreported information, collection company pickup unreported information and collection center delivery unreported information; and
one or more of these pieces of information is transmitted to a reception management center via a network, and completion of collection and delivery for these management numbers is registered by registering the collection report date of the collection delivery information, collection company pickup report date and collection center delivery report date.

9. A collection/recycling collection item acceptance disassembly management method for products using network means which can acquire collection application information such as a management number, collection application item type and collection application item quantity, collection request information such as the name of the collection company, and a storage device which stores collection item management information such as this collection application information, collection request information and collection item acceptance date, wherein:
the collection application information and collection request information are previously acquired via the network means, and registered as collection item management information, and when the collection item is accepted, the collection item management information is searched using the input management number, and acceptance of the collection item is managed by registering acceptance date information relating to this management number.

10. The collection/recycling collection item acceptance disassembly management method for products as defined in claim 9, using network means which can acquire collection application information such as a management number, collection application item type and collection application item quantity, and collection request information such as the name of the collection company, and a storage device which stores collection item management information such as this collection application information, collection request information and collection item acceptance date, wherein:
the collection application information and collection request information are previously acquired via the network means, and registered as collection item management information, and when the collection item is accepted, the collection item management information is searched using the input management number and acceptance date information relating to this management number is registered, and when this collection item management information contains information categories which still have no input or have incorrect input, a screen suggesting input of the insufficient or incorrect information is automatically displayed; and
the collection/recycling of the collection item having this management number is managed by registering or updating the information in the storage device using the information input on this screen.

11. The collection/recycling collection item acceptance disassembly management method for products as defined in claim 9, using network means which can acquire collection application information such as a management number, collection application item type and collection application item quantity, and collection request information such as the name of the collection company, and a storage device which stores collection item management information such as this collection application information, collection request information and collection item acceptance date, wherein:
the collection application information and collection request information are previously acquired via the network means, and registered as collection item management information, and when the collection item is accepted, the collection item management information is searched using the input management number; and
when collection item management information for this management number does not exist, a screen suggesting input of collection item management information is automatically displayed, and by registering this information in a storage device by information input on the screen, the collection/recycling of the collection item having this management number is managed, collection/recycling is more highly computerized and efficiency is improved.

12. A collection/recycling collection item acceptance disassembly management method for products using a storage device which stores collection application information such as management number, collection application item type and collection application item quantity, collection request information such as scheduled collection date and name of collection company, and collection item management information comprising the collection item acceptance date, and the disassembly date comprising re-use of products or parts in the collection item, wherein:
collection management information is searched using the management number for the collection item when the collection item is introduced to the disassembly line comprising re-use of products and parts, or when it is decided to perform disassembly comprising re-use products and parts, and the disassembly comprising re-use of products and parts in the collection item is managed by registering the disassembly date in this information.

13. A collection/recycling collection item acceptance disassembly management method for products using a storage device which stores collection application information such as management number, collection application item type and collection application item quantity, collection request information such as scheduled collection date and name of collection company, and collection item management information comprising the collection item acceptance date, collection item acceptance report date, collection item disassembly date and collection item disassembly report date, wherein:
one or more pieces of information comprising information for which the collection item acceptance date is registered but the collection item acceptance report date is not yet registered, and information for which the collection item disassembly date is registered but the collection item disassembly report date is not yet registered, is extracted by searching the collection item management information;
all or part of the acceptance complete report information such as the management number, name of the collection center and acceptance date, and the disassembly complete report information such as the management number, name of the collection center and disassembly date is generated using this collection item management information, taking the above information as collection item acceptance complete unreported information and collection item disassembly complete unregistered information and one or more of these pieces of information is transmitted to the reception management center via the network, and completion of acceptance and disassembly for information having this management number is registered by registering the collection item acceptance report date and the collection item disassembly report date in the collection item management information.

14. The collection/recycling collection item acceptance disassembly management method for products as defined in claim 13, using a storage device which stores collection application information such as management number, collection application item type and collection application item quantity, collection request information such as scheduled collection date and name of collection company, and collection item management information comprising the collection item acceptance date, collection item acceptance report date, collection item disassembly date and collection item disassembly report date, wherein:
one or more pieces of information comprising information for which the collection item acceptance date is registered but the collection item acceptance report date is not yet registered, and information for which the collection item disassembly date is registered but the collection item disassembly report date is not yet registered, is extracted by searching the collection item management information; and
all or part of the acceptance complete report information such as the management number, name of the collection center and acceptance date, collection application item information to which information may be added at this base, disassembly complete report information such as the management number, name of the collection center and disassembly date, and collection application item information to which information may be is added at this base, is generated using this collection item management information, taking the above information as collection item acceptance complete unreported information and collection item disassembly complete unregistered information; and
one or more of these pieces of information is transmitted to the reception management center via the network, and completion of acceptance and disassembly for information having this management number is registered by registering the collection item acceptance report date and the collection item disassembly report date in the collection item management information.

15. A collection/recycling recycle rate management method for products using a storage device which stores incoming information such as incoming date, incoming weight and category, outgoing information such as outgoing date, outgoing content, outgoing weight and outgoing classification, and collection item information such as management number, model, category and weight, means for reading the management number of the incoming item, and means for measuring the weight of the outgoing item, wherein:
the collection item information is searched using the read management number when disassembly is performed on the collection acceptance item, and the category and weight are extracted, and stored in a storage device;
the weight is measured at the outgoing stage and stored in the storage device together with the outgoing category;
the storage device is searched automatically at a predetermined command at a predetermined interval, and the incoming and outgoing results relating to the specified or predetermined interval are extracted; and
the recycle rate for the interval concerned is managed using the sum total of incoming weight during the extracted interval, and the sum total of weight relating to items which, of the outgoing weight in the interval concerned, have a suitable outgoing classification or outgoing content for recycling.

16. A collection/recycling recycle rate management method for products, comprising a storage device which stores incoming information such as incoming date, incoming weight and category, acceptance/outgoing information such as outgoing management number, outgoing date, outgoing content, outgoing weight and outgoing classification, and subcontractor result information comprising outgoing management number, report date and recycle results, input/registration means which automatically acquires/registers subcontractor result information via a network from a subcontractor or uses an input device such as a keyboard, means which reads the management number of the incoming item and means which measures the weight of the outgoing item, wherein:
the collection item information is searched using the read management number when disassembly is performed on the collection acceptance item, the category and weight are extracted, and stored in the storage device;
the weight is measured at the outgoing stage, and registered and stored in the storage device, and subcontractor result information acquired via the network from the subcontractor is registered in the storage device;
the acceptance incoming information and subcontractor result information in the storage device is automatically searched at a predetermined command or at a predetermined interval, and acceptance and outgoing results related to the specified or predetermined interval are extracted;
the sum total of the acceptance weight in the extracted period, the sum total of information relating to outgoing classification or outgoing content suitable for recycling in the outgoing weight in the same interval, and the weight relating to information having suitable outgoing classification or outgoing content for subcontracting in the outgoing weight during the same period, are summed by computing the weight which was actually recycled in the corresponding weight using subcontractor result information where subcontracting has the same number as the outgoing management number in the outgoing results or the same content, and the recycle rate in this interval is managed by using these sum totals.

17. A collection/recycle management method as defined in claim 1, wherein needs information for re-use products and parts is collected from the parts center system, and collection/recycling is performed comprising the re-use of products and parts by extracting re-use products and re-use parts based on said needs information in the collection center system.

18. A support method for the re-use of products and parts in the collection/recycling of products, using a storage device which stores product specification information comprising manufacturer name, model, year and specification, product composition information comprising parts model and quantity, parts specification information comprising parts model and parts specification, required re-use products/parts information comprising the name of a parts center, required product specification, required product model, required product year, required parts model, required parts specification, required quantity and desired price, parts center information comprising the name of the parts center, its location and contact details, and collection item management information for managing the product model and quantity of collection items which have been accepted or are scheduled to be accepted, together with an output device, wherein:
said product specification information, product composition information, parts specification information, required re-use products/parts information and parts center information are input from a reception management center system, or collection item management information receives input from the reception management center system when the collection items are received; and
required re-use products contained in the collection items are extracted by searching the collection item management information using said required re-use product information, or the parts composition contained in the collection items is extracted from the collection item management information and parts composition information, the products having the required re-use parts contained in the collection items are extracted by searching the parts composition using the required re-use parts information, and extracted products or parts which have a possibility of re-use are clearly indicated by outputting these extracted, required re-use products and products from which parts can be obtained, from the output device.

19. A support method for the re-use of products and parts in the collection/recycling of products, using a storage device which stores re-use item management information comprising a re-use item management number, re-use item model, quantity, sales price, name of a parts center to which the sale is made, name of collection center in which extraction of re-use items is made, disassembly date, delivery date and delivery report date, and network means which transmits the re-use item extraction information to a reception management center system, wherein:
when collection items are disassembled, the required disassembly is performed on products and parts which have re-use needs according to instructions, and a re-use item management number is individually assigned;
re-use products and re-use parts are registered in the storage device according to their model, quantity, sales price, name of collection center in which extraction of re-use items is made, name of the parts center to which they are sold and disassembly date together with a re-use item management number attached to the product or part, and re-use item extraction information such as the name of the parts center to which they are sold, re-use item model and quantity is generated using this information, and
the re-use product or part is managed by transmitting one or more pieces of this information to the reception management center via the network means.

20. A support method for the re-use of products and parts in the collection/recycling of products, using a storage device which stores re-use item management information comprising a re-use item management number, re-use item model, quantity, sales price, name of a parts center to which the sale is made, name of collection center in which extraction of re-use items is made, disassembly date, delivery date and delivery report date, and parts center information comprising the name of the parts center, location and contact details, an output device, a device for inputting the
re-use item management number, and network means which transmits re-use item delivery information to the parts center, wherein:
the re-use item management information in the storage device is searched using the re-use item management number input from the input device, the parts center information in the storage device is searched using the name of the parts center to which the item is sold in the re-use item management information, and the contact details of the parts center are extracted;
delivery instructions are issued by outputting the delivery address for the re-use items on a screen or delivery form using this re-use item management information and parts center information; and
the parts center system is informed of the delivery by transmitting this information via network means, and the delivery of the re-use items in this information is managed by storing the delivery date in this information.

21. A support method for the re-use of products and parts in the collection/recycling of products, using a storage device which stores re-use item management information comprising a re-use item management number, re-use item model, quantity, sales price, name of a parts center to which the sale is made, name of collection center in which extraction of re-use items is made, processing date, delivery date and delivery report date, wherein:
said storage device is searched at a predetermined command or at a certain interval, and information for which the delivery date is registered but the delivery report date is not registered, is extracted;
re-use item delivery information is generated comprising the re-use item management number, re-use item model, quantity, sales price, name of the parts center to which delivery is made, name of collection center in which extraction of re-use items is made, and delivery date, using this information, where the above information is delivery unreported information; and
one or more pieces of this information are transmitted to the reception management center via a network, and a re-use item delivery report is made regarding information having this re-use item management number by registering the delivery report date.

22. A support method for the re-use of products and parts in the collection/recycling of products, using a storage device which stores re-use item management information comprising a re-use item management number, re-use item model, quantity, sales price, name of a name of collection center to which the sale is made, delivery report date, cost invoice date and cost collection date, and a device which receives re-use item delivery information from a collection center system comprising the name of the collection center, re-use item management number, re-use item model, quantity, sales price, name of the parts center to which items are sold and delivery date, wherein:
the re-use item delivery information transmitted by the collection center system is received, and provision of the re-use item from the collection center to the parts center is managed by storing the name of the collection center, re-use item management number, re-use item model, quantity, sales price, name of the parts center to which the item is sold and delivery report date in the storage device.
